(19) United States
(12) Patent Application Publication
(10) Pub. No.: US 2016/0042598 A1
(43) Pub. Date: Feb. 11, 2016

(54) Interactive Module With Activity Credit Negotiation Logic

(71) Applicants: Eric P. Schwartz, Austin, TX (US); Eric N. Abrahams, Austin, TX (US)

(72) Inventors: Eric P. Schwartz, Austin, TX (US); Eric N. Abrahams, Austin, TX (US)

(73) Assignee: E-SQUARED LABS, INC., Austin, TX (US)

(21) Appl. No.: 14/887,269

(22) Filed: Oct. 19, 2015

Related U.S. Application Data
(63) Continuation-in-part of application No. 14/242,110, filed on Apr. 1, 2014.

(51) Int. Cl. G07F 17/32; H04L 29/08

(52) U.S. Cl. CPC G07F 17/3223; H04L 67/104; G07F 17/3244

(57) ABSTRACT

An interactive module is configured to engage in communications that relate a game or activity with another interactive module. Utilizing position identification circuitry and/or acceleration determination circuitry, the interactive module identifies a defined active motion based upon data generated by at least one of the position determination circuitry and the acceleration circuitry. The interactive module then, stores an indication of an event and exchanges data based upon identifying the defined active motion directly with the second interactive module. In one embodiment, the record keeping is based in part, upon the activity of the module and also in part by an identity of the proximate interactive module. The interactive module is configured to engage in communications to exchange credits, currency or rewards that are generated in response to the defined activities, motions or events.

### BACKGROUND

1. Technical Field

The present invention relates to interactive game and activity modules and, more particularly, devices for use in single and group game and activity situations.

2. Related Art

The Golden age for gaming systems started in the 1980s. Some of the industry's first contenders were Sega, Genesis and Nintendo. During the 1990s, Nintendo and Sega became the Giants of gaming systems until Sony came into the market forever changing the types of systems that were available and their capabilities. These gaming systems brought the pleasures of an arcade into the home. Traditionally, a gaming system included a gaming console, at least one port for receiving a hardware module that included software that defined game rules, graphics software and instructions, and at least two connector ports for input devices such as joysticks, keypads, etc. One aspect of each of these original gaming systems is that the joysticks or other input devices were all physically tethered to the gaming console.

In the late 1990s and early 2000's, handheld gaming devices became popular in which a stand alone system included a display, at least one speaker, and internal logic for generating graphics and for defining the game. The technology for the larger and more traditional gaming systems progressed wherein input devices communicated with the game controller via a wireless communication link instead of via a wired tether. While the input devices for these new systems were wireless, they typically consisted of keypads with various control buttons and joysticks and were limited to use within a close distance to the game console due to limitations in the communication technology.

Recently, the nature of the input devices changed wherein the input devices include accelerometers and communication circuitry that provide an indication of motion to the console unit via a wireless communication link. For one example of such technology, the Nintendo WHO includes input devices that can be held in the palm of a hand, such as a racket or baton, that includes the accelerometers to support games that are related to activities such as tennis, bowling, boxing and golf. The Nintendo Wii input devices do not, however, include control software or game logic. They merely transmit action/selection indication signals to the gaming console that are based upon one or more button depressions and/or a movement. The movements are not necessarily well defined and technically correct actions. In usage, it appears that the primary data being transmitted is related to speed and acceleration and not so much to a specified action in a specified direction.

The input devices for the Nintendo Wii, while being wireless, are required to be within a close distance to the gaming console and to communicate with the gaming console to deliver action/selection information. The user's actions are prompted by what is shown on a television screen.

While many wonderful applications have been and can be developed for such technology, there are limitations that are inherent to the current form factors that require interaction between the input devices and the gaming console. The present inventors have realized, therefore, that what is needed, therefore are devices that are not limited by current technology form factor based constraints to facilitate the creation of new games and activities.

### BRIEF DESCRIPTION OF THE DRAWINGS

A better understanding of the present invention can be obtained when the following detailed description of the preferred embodiment is considered with the following drawings, in which:

FIG. 1 is a functional network diagram containing a plurality of interactive modules according to one embodiment of the invention.

FIG. 2 is a functional block diagram of an interactive module according to one embodiment of the invention.

FIG. 3 is a functional block diagram of an interactive module 100 that includes a base unit and an interchangeable unit.

FIG. 4 is a functional block diagram illustrating one embodiment of the invention.

FIG. 5 is a series of drawings that illustrates a plurality of movement patterns for exemplary purposes.

FIG. 6 is a functional block diagram of an action recognition module according to one embodiment of the invention.

FIG. 7 is a flow chart illustrating a method according to one embodiment of the invention.

FIG. 8 is a flow chart that illustrates a method according to one embodiment of the invention.

FIG. 9 is a flow chart that illustrates an interactive method between two interactive modules according to one embodiment of the invention.

FIG. 10 is a flow chart that illustrates one aspect of an embodiment of the present invention.

FIG. 11 is a flow chart that illustrates one aspect of an embodiment of the present invention.

FIG. 12 is a signal flow diagram that illustrates a method according to one embodiment of the invention for defining game/activity rules.

FIG. 13 is a functional diagram illustrating a network of interactive modules that operate according to one embodiment of the invention.

FIG. 14 is a flow chart that illustrates a method of communication in a network of interactive devices according to one embodiment of the invention.

FIG. 15 is a functional network diagram containing a plurality of interactive modules according to one embodiment of the invention.

FIG. 16 is a flowchart that illustrates a method for generating currency by an interactive module or by an interactive module and a game server or application server.

FIG. 17 is a flowchart that illustrates a method for generating currency and reward levels according to one embodiment of the present invention.

FIG. 18 is a flowchart that illustrates a method for generating currency and reward levels according to one embodiment of the present invention.

FIG. 19 is a functional block diagram of an interactive module according to one embodiment of the invention.

FIG. 20 illustrates various aspects of one embodiment of an interactive module.

FIG. 21 is a signal sequence diagram that illustrates operation according to one embodiment of the invention.

FIG. 22 is a signal sequence diagram that illustrates operation according to an alternative embodiment of the invention.

FIG. 23 is a functional block diagram of an interactive module configured to exchange currency with a plurality of interactive modules according to one embodiment of the present invention.

FIG. 24 is a functional block diagram of an interactive system according to one embodiment.

FIG. 25 is a functional block diagram of an application server according to one embodiment.

FIG. 26 is a signal sequence diagram that illustrates one aspect of the embodiments of the present invention.

### DETAILED DESCRIPTION OF THE DRAWINGS

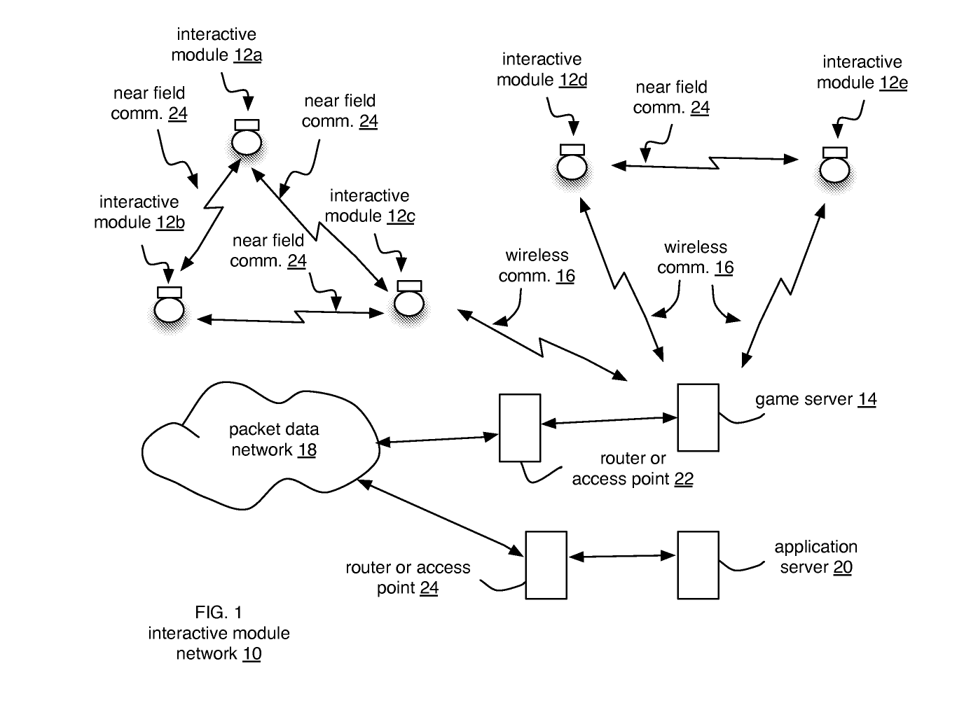

FIG. 1 is a functional network diagram containing a plurality of interactive modules according to one embodiment of the invention. Referring to FIG. 1, an interactive module network 10 includes a plurality of interactive modules 12a-12e that are configured to communicate directly with each other in a device-to-device (D2D) mode as well as communicating via one or more of a router, access point, or game/activity server 14 via a data packet network such as the Internet. In one embodiment, a game/activity server 14 (hereinafter, game server 14 or GS 14) initializes a game or activity via a wireless communication link 16. A GS 14 may be a dedicated device or a computing unit with an associated program or application.

In one embodiment, the wireless communication link 16 is a WLAN communication link such as those defined by the various I.E.E.E. 802.11 communication protocols. Other communication protocols may also be used. For example, the wireless communication link may be one according to a Bluetooth protocol or a personal area network (PAN) protocol. It should be noted that the interactive modules also may be configured to initiate a game or activity. In one embodiment, a defined motion of the interactive module may, upon being recognized by internal logic within the interactive module, trigger a method or process to initiate the game or activity.

A GS 14 may be a standalone device having game/activity rules and logic installed within its memory and/or circuitry. Alternatively, GS 14 may include or be in communication with a wireless router or access point 22 that is communicatively coupled to a packet data network 18 such as one of the many versions of the Internet to ultimately communicate with a remote application server 20 via a router or access point 24.

Each of the interactive modules 12a-e is configured to communicate with GS 14 via a first wireless communication link 16 as well as with each other according to any one of a plurality of D2D communication protocols such as I.E.E.E. 802.15 or a personal area network communication protocol (e.g., Bluetooth) or a near-field communications (NFC) protocol such as NFC communication link 24. Here in FIG. 1, wireless communication link 16 is a WLAN type communication link that operates according to one or more I.E.E.E. 802.11 type communication standards. Communication link 24 is illustrated as a Near Field Communications (NFC) communication link but it should be understood that the invention is not so limited. Any peer-to-peer type of communication link may be used that supports device-to-device communications.

In operation, a method for the interactive modules comprises determining that a second interactive module is proximate to the first interactive module, and utilizing at least one of a position identification circuitry and an acceleration determination circuitry to identify a defined active motion based upon data generated by the at least one of the position determination circuitry and the acceleration circuitry.

In one embodiment of the invention, devices such as the first and second interactive modules are operable to determine that they are proximate to each other by detecting a beacon transmitted by the other device and/or a radiofrequency signal that can only be received and recognized within a certain range or distance. In an alternative embodiment, a remote device, such as a game server, generates a communication signal to the interactive devices to inform them that they are proximate to each other. For example, if each interactive module has a position determination circuit, such as a global positioning system (GPS) receiver, the interactive modules can forward location information to the game server, here game server 14, to enable game server 14 to determine with specified logic that the first and second interactive devices are proximate to each other. Once such a determination is made, the game server 14 communicates with the first and second interactive modules to advise them that they are proximate to each other. Alternatively, game server 14 may transmit position information of at least one of the first and second interactive modules to allow one or both of the interactive modules to determine that the other is proximate.

Once the first and second interactive modules have determined that they are proximate to each other, then they may enter into a game or activity mode or, alternatively, a communication mode to exchange game/activity rules or game/activity data (generally, game/activity information). For example, utilizing at least one of position identification circuitry and acceleration determination circuitry, the first interactive module is configured to identify a defined active motion based upon data generated by the position determination circuitry and/or acceleration circuitry that prompts the first interactive module to enter into a corresponding game or activity mode and/or to initiate communications with the second interactive module to jointly enter into the corresponding game or activity mode or to exchange the game/activity information.

Once the first interactive module has not only determined that it is proximate to the second interactive module, but also that a defined active motion that corresponds to the game or activity has been performed by the user, the first interactive module, after establishing a communication link with the second interactive module, stores an indication of the event (based upon identified and defined active motion) and exchanges game/activity information based upon the identified defined active motion directly with the second interactive module. The exchanged game/activity information may be any one or more of an updated score, an indication of the identified action, or even a command or prompt to trigger a desired response by the user of the second interactive module or rules for the game/activity.

In one embodiment of the invention, each interactive module includes memory that stores a library of defined moves and activities. The library of defined moves includes moves that are interactive by nature, such as performing a high five, shaking hands, boxing, dancing, rock paper scissors, copycat moves, exercise moves, hugging, secret handshakes and communication gestures as well as moves for virtual games such as virtual ping pong.

The library of defined moves also includes moves that are singular and not interactive. For example, the library of the defined moves may relate to identifiable moves such as jogging, tooth brushing, rope jumping, jumping jacks, etc. It should be understood, of course, that the library of defined moves might require the interactive module to be worn on a specified body part to be able to properly identify and record the activity.

Generally, the interactive module may be used not only as a gaming device, but also as a part of a system that encourages certain behaviors and activities such as exercise or tooth brushing. Because the interactive modules are configured to keep a score, or tally or records according to a set of rules, minimum thresholds of certain activities may be defined and subsequently rewarded. For example, the interactive module can not only track how many steps a person walks, how many exercises of a certain type are performed, such as bench presses or jumping jacks, but also other activities such as how many strokes a child used to brush his or her teeth to ensure that the teeth are being brushed properly. Accordingly, award systems may be defined via a user interface to generate an award or recognition of specified accomplishments.

Additionally, because the interactive module is configured to enter into a selected mode, game or activity upon determining that another interactive module is proximate, special games may be created and/or defined. For example, the childhood game of tag may be modified to utilize a virtual token that is handed off from one person (or more specifically, one interactive module) to another when the two individuals or devices come into contact with (within a defined distance) each other.

In keeping with the above, games and activities may be defined that require participation by a group of individuals. Additionally, the individuals may be organized into separate groups wherein the scorekeeping or tally is based not only on interaction, but also upon organization or arrangement. Games may be defined, for example, that have two or more teams wherein scoring is based upon an activity in relation to the identity or membership of a proximate individual. One significant aspect of the embodiments of the present invention, therefore, is that record-keeping, which includes keeping a score or tally, depends not only upon identified actions being performed, but also upon determining a relative proximity of an individual or specified device and the group and/or individual identity of that user or user device.

Additionally, once the interactive module determines that it is proximate to another device, or has just become proximate, the interactive module is configured to identify actions that serve as a command to enter into a game or activity or mode. The game, activity or mode that is entered into may be based on the identity of the proximate interactive device and, possibly, the present mode of the interactive module. Thus, depending on the present mode when the second interactive module becomes proximate to the first interactive module, a subsequent mode or activity may be defined that affects how defined actions are scored, recorded, or tallied.

More generally, the capabilities of the interactive modules are intended to encourage fitness and movement, to make individual and group activities more fun, to reward positive behavior, whether individualized or as a part of a group, and to create a unique physical social network. If an interactive module is configured to determine when it is proximate to a specified computer, gaming device, or server, the defined actions may be utilized in conjunction with certain activities for online gaming. Similarly, the interactive module may interact with external devices such as smart phones and accessories of other types to generate commands or data to be transmitted to the external devices.

As another aspect of the embodiments of the present invention, the interactive modules may be configured to record certain types of activities and motions that are later uploaded to a remote server via an access point and data packet network such as the Internet. For users that allow such data collection to occur, the data may be utilized to improve target marketing and/or product development. For example, it is known that there are companies that collect such data to render their advertising and product development efforts more efficient and effective.

The embodiments of the interactive modules bus include any one of a number of different types of motion and position recognition circuits, devices and systems such as accelerometers, gyroscopes, magnetometers and GPS receivers that may be utilized either singly or in combination to identify location, movement, actions, orientation, speed and acceleration. Any reference herein to position identification circuitry and acceleration determination circuitry should be understood to potentially include any combination of accelerometers, gyroscopes, magnetometers and GPS receivers.

The interactive modules may be packaged or physically configured to be wrist worn (as a watch), or to be worn on other limbs or locations of the body such as the head, leg, upper arm or torso. Generally, the interactive modules will be configured to be stylish or attractive and comfortable to wear as well as to be durable.

Additionally, the interactive modules will include communication circuitry to enable data to be uploaded and downloaded to facilitate coordination, communication and control. For example, in one embodiment, an interactive module may include a USB port to enable the device to be coupled to a computer. Alternatively, or additionally, the interactive modules can include a wireless communication radio and corresponding protocol logic to enable the interactive module to communicate with a computer via a wireless link such as a Bluetooth or a Wi-Fi or WLAN communication protocol such as I.E.E.E. 802.11. The logic would, in the case of Bluetooth, as well as other protocols, include pairing logic to enable the two devices to be paired for subsequent communications.

As another aspect of the embodiments of the present invention, the interactive modules may be configured to store user location information in relation to a downloaded map that is stored in memory to allow a parent to understand where the user, e.g., a child, has gone during the day. Moreover, in one embodiment, such a downloaded map includes defined prohibited areas that prompts the interactive module to generate alarms to remind the user that he or she is within or approaching a prohibited area. In yet another embodiment of the invention, the interactive module includes wireless communication circuitry to enable it to generate text messages for transmission via any one of a cellular communication protocol, a WLAN communication protocol such as 802.11 or a personal area network communication protocol such as Bluetooth to a specified user such as a parent to inform the specified user of the location and/or activity of the person using the interactive module.

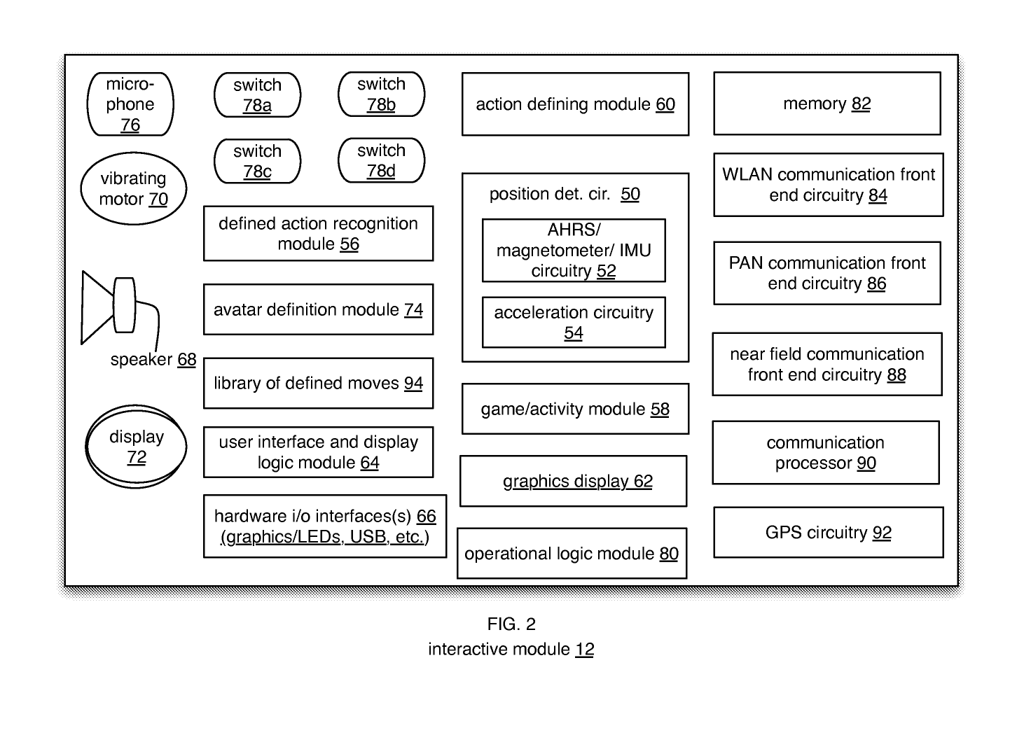

FIG. 2 is a functional block diagram of an interactive module according to one embodiment of the invention. Referring to FIG. 2, interactive module 12 (which can be any one of modules 12a-e of FIG. 1 includes modules that support communications, motion and position and location determination, game and activity rules, displays, interface hardware, and at least one module for identifying defined actions as well as user interface modules. All of these modules work in concert to create an interactive module that supports new types of games and activities not previously supported by existing gaming systems and their input devices.

More specifically, interactive module 12 includes position determination circuitry 50 that further includes one or more of an attitude and heading reference system (AHRS), a magnetometer and an inertial measurement unit (IMU) circuitry 52 and acceleration circuitry 54. Interactive module 12 also includes a defined action recognition module 56 that is configured to receive position and/or acceleration data from position determination circuitry 50 to determine if a defined action has been performed.

Interactive module 12 also includes a game/activity module 58 that communicates with defined action recognition module 56 to determine how to interact with another interactive module and/or how to score, record or tally the defined action that was recognized by defined action recognition module 56. For example, game/activity module 58 may include game or activity rules that are processed in view of the recognized actions by defined action recognition module 56 to determine how to record an event or even a mode of operation. Additionally, interactive module 12 includes an action-defining module 60 that defines logic for creating a library of defined actions that may be recognized by defined action recognition module 56. Action defining module 60 is configured to receive position and acceleration data from position determination circuitry 50 while in a learning mode and to store the received position and acceleration data to define an action. The defined actions are then stored in a library of defined moves 94.

In one embodiment of the invention, action defining module 60 is configured to communicate with a user via any one of a plurality of user interface devices, such as graphics display 62, user interface and display logic module 64, hardware I/O interfaces 66, speaker 68, vibrating motor 70, and display 72, to generate prompts and/or to receive names or identifiers for the recorded actions. For example, action-defining module 60 may generate a feedback signal to the user asking the user to give a name to a recorded action that has just been defined. If, for example, an action has been defined, action-defining module 60 may communicate with graphics display module 62 or with display 72 to generate a text message for the user to request that the user enter a name for the recorded action that has just been defined.

Alternatively, action-defining module may prompt a user in that way by generating a message or a light that is displayed directly by display 72. Alternatively, action-defining module 60 may generate a voice message or tone that is played by speaker 68 to prompt the user to enter a name for the defined action. A vibrating motor 70 may also be used as a prompt or a feedback device for communicating with the user.

Another way of communicating with the user is through the use of a customized cartoon image (avatar). Accordingly, interactive module 12 includes an avatar definition module 74 that allows a user to create an avatar for communicating results or messages to the user or to prompt the user to perform a specified action.

As may also be seen, interactive module 12 includes a microphone 76 that allows the user to respond to any prompt generated by any means with a verbal response. For example, if action defining module 60 prompts the user to generate a name for a recently recorded and defined action, any voice that is recognized or received by microphone 76 may be produced to processing logic to convert the same to text which is then associated to the newly defined action by action defining module 60.

Continuing to examine FIG. 2, the interactive module 12 includes a plurality of switches 78a-d that may be used for turning a module on or off as well as to select from a variety of options given to the user via any of the user interface display or sound elements.

More generally, an operational logic module 80 includes operational logic to coordinate the plurality of modules and their associated functions and communications with each other as well as with the user. Moreover, a memory 82 includes temporary computer instructions and data as well as computer instructions and data that are stored on a permanent basis or until deleted or replaced. Other circuits or elements of interactive module 12 include a wireless local area network (WLAN) communication front end circuitry 84, personal area network (PAN) 86, near field communication (NFC) front end circuitry 88, as well as a communication processor 90 and global positioning circuitry (GPS) 92.

Each of the modules, circuits and elements of interactive module 12 may be configured to operate according to the various embodiments of the present invention as described here in relation to FIG. 1 described above as well as the figures described below. An interactive module 12 is not required to include all of the modules shown within FIG. 2 and may include other modules not described here. Moreover, the logic of the various modules may be combined or defined in different manners.

Any logic of graphics display module 62, for example, could be included with user interface and display logic module 64. Alternatively, user interface and display logic module 64 may define interface related logic for various devices including graphics devices while graphics display module 62 generates actual display signals that are to be shown on a display via an interface controlled by user interface and display logic module 64. It should also be understood that the methods of various flow charts described in the present specification and the logic therefor may be implemented within the various modules and circuitry described in relation to FIG. 2.

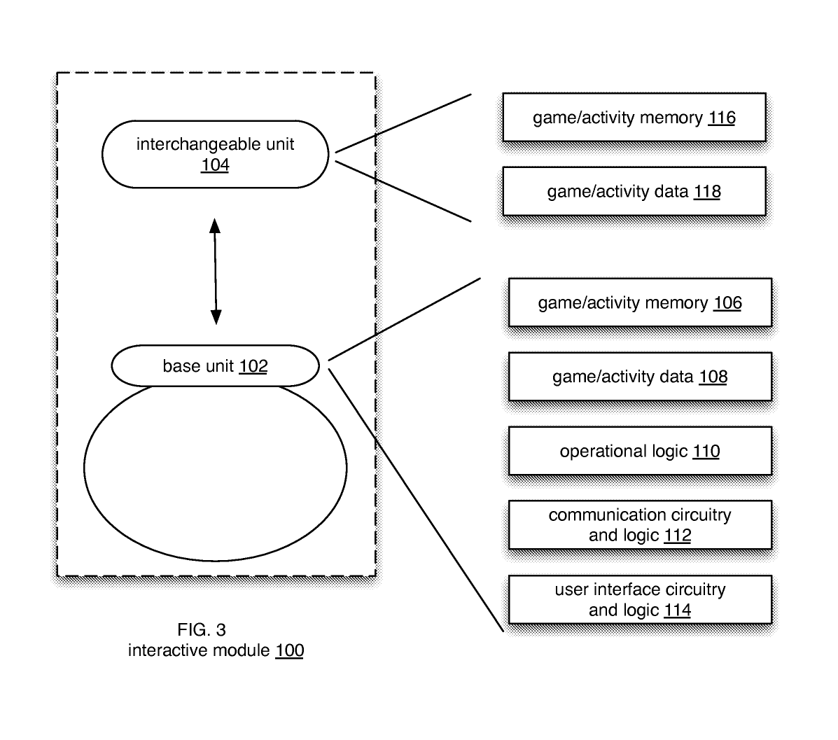

FIG. 3 is a functional block diagram of an interactive module 100 that includes a base unit 102 and an interchangeable unit 104. Interactive module 100 includes a base unit 102 that further includes the elements described in relation to FIG. 2 and/or a game/activity memory module 106, a game/activity data module 108, operational logic module 110, communication circuitry and logic module 112, and user interface circuitry and logic module 114. Interactive module 100 further includes an interchangeable unit 104 that further includes game/activity memory module 116 and game/activity data module 118.

One aspect of the embodiment of FIG. 3 is that interchangeable unit 104 includes a game/activity memory module 116 that is similar to game/activity memory module 106 and a game/activity data module 118 that is similar to game/activity data module 108. These duplicate modules 116 and 118, because they are part of interchangeable unit 104, which may be removed from base unit 102 to be placed on a base unit of another interactive module 100, are required to support sharing of defined motions and record-keeping as the interchangeable units are installed on different base units 102.

Accordingly, when an interactive unit 104 is coupled to a base unit 102, the base unit 102 and interchangeable unit 104 are configured to exchange game/activity data stored in game/activity data modules 118 and 108. For example, if base unit 102 modifies its stored records, for example, a score for a particular game, and also learns a new defined action that is stored within its internal circuitry, such stored records and newly defined action may be uploaded to interchangeable unit 104.

Similarly, when interchangeable unit 104 is coupled to base unit 102, any record-keeping and/or defined actions stored therein may be downloaded to base unit 102. This interoperability allows interchangeable units 104 to be exchanged between users to share defined actions and/or games and/or activities. In one embodiment, time tags are associated with each recorded set of rules/data so older data or rules do not overwrite current rules/data.

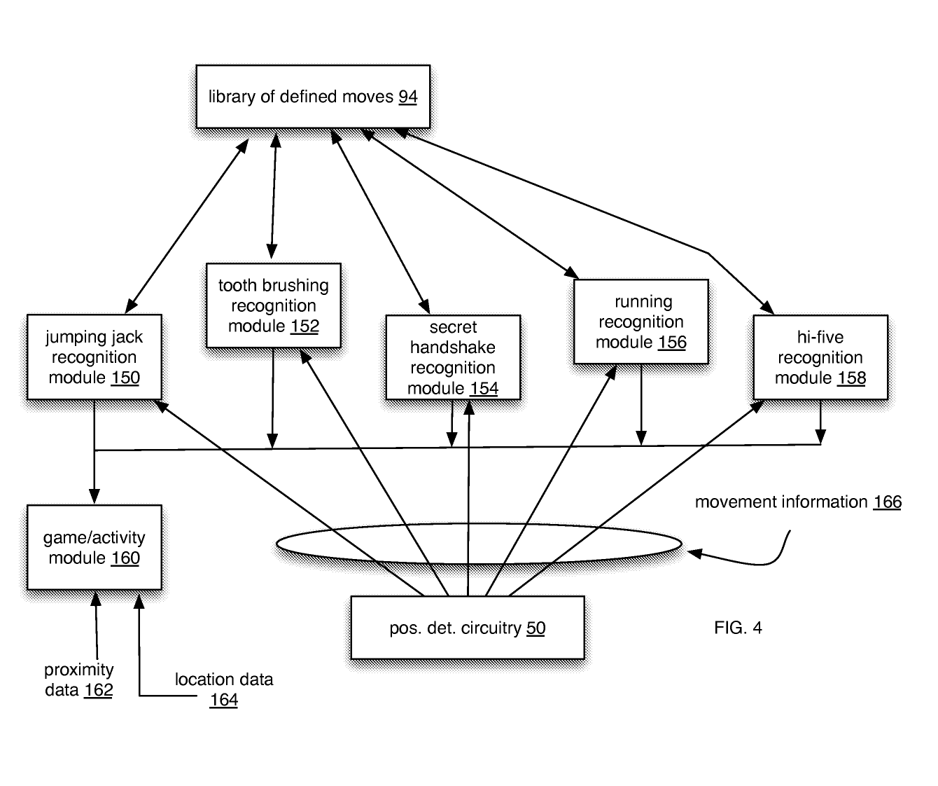

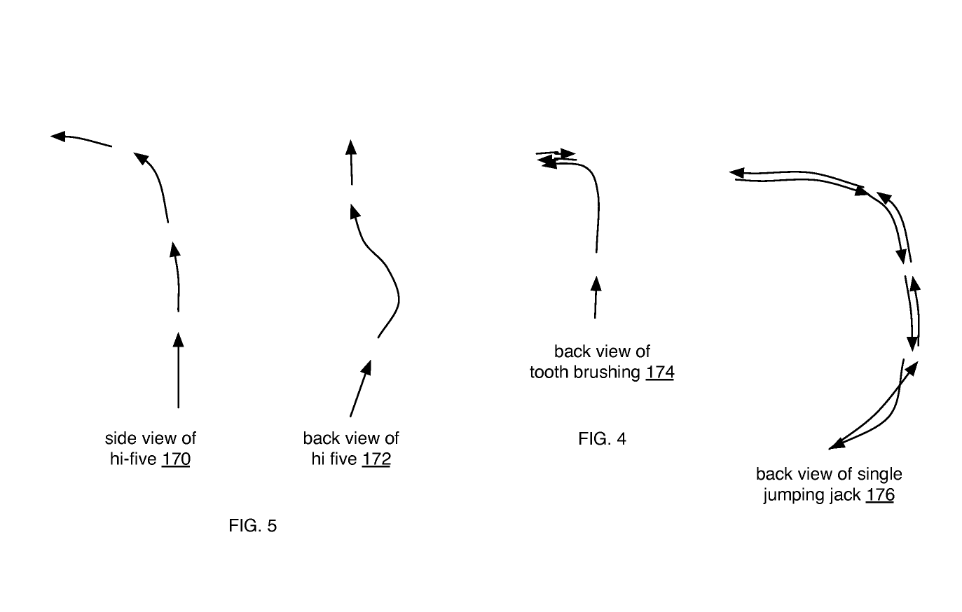

FIG. 4 is a functional block diagram illustrating one embodiment of the invention. In the embodiment of FIG. 4, each of a plurality of modules communicate with both the position determination circuitry 50 and the library of defined moves 94 to determine whether a defined action or movement has occurred. More specifically, the position determination circuitry 50 produces movement information 166, which can comprise location, a movement pattern, and acceleration, or a speed, or combination thereof, to each of a plurality of modules that determine whether a specified action or movement has occurred. In the example of FIG. 4, a jumping jack recognition module 150, a tooth-brushing recognition module 152, a secret handshake recognition module 154, a running recognition module 156 or a high-five recognition module 158 is each coupled to receive movement information 166 from position determination circuitry 50.

Each of these modules is further configured to communicate with the library of defined moves module 94 to compare the received movement information to the library of defined moves to determine if a defined move or action has occurred. If a defined move or action has occurred, each of the modules 150-158 is configured to convey to game/activity module 160 an indication of the recognized move or action. Game/activity module 160 is configured to perform any necessary scoring or record keeping associated with the recognized move or action. As may also be seen, game/activity module 160 is configured to receive proximity data 162 and location data 164 which may affect the interpretation or record keeping or scorekeeping for the recognized move or action.

FIG. 5 is a series of drawings that illustrates a plurality of movement patterns for exemplary purposes. More specifically, a side view of a high-five 170, a back view of a high-five 172, a back view of tooth brushing 174 and a back view of a single jumping jack 176 are shown. These movement patterns illustrate a portion of the movement information 166 generated by the position determination circuitry 50 (FIG. 2) that may be produced to a defined action recognition module 56 (FIG. 2) or to any of the modules 150-158 (FIG. 4).

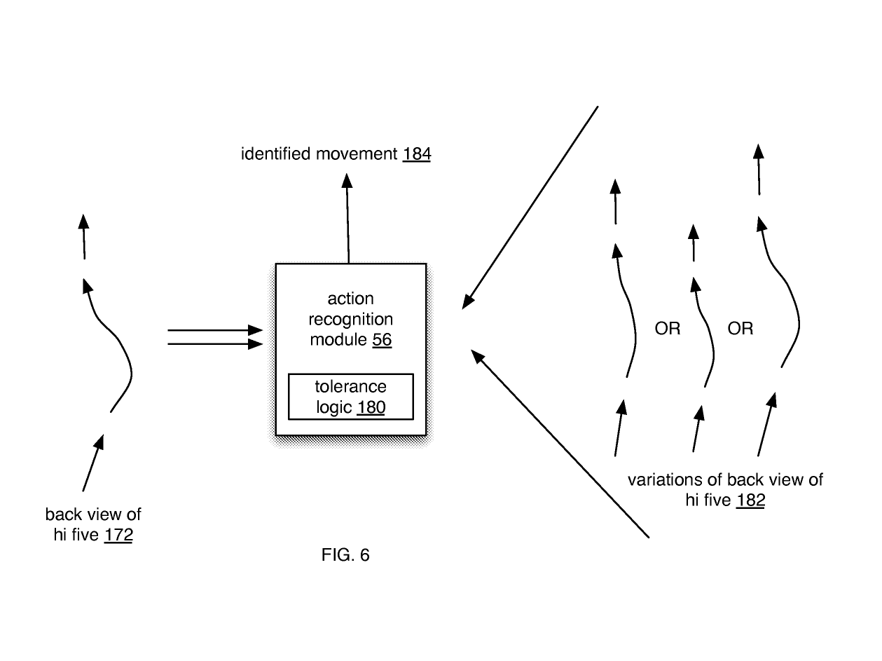

FIG. 6 is a functional block diagram of an action recognition module according to one embodiment of the invention. Action recognition module 56 includes tolerance logic 180 that includes logic for identifying a movement even if the movement is not exactly the same as a defined action. For example, if a defined action is for a high-five, but the movement varies slightly from the defined action, tolerance logic 180 is configured to identify the movement or action even though there is some variation.

To illustrate, for a back view 172 of a high-five (as the defined action), if the actual movement is one of the three variations of the back view of the hi five 182, tolerance logic is configured to determine that the actual movement is the defined action within a range of acceptable variations that allows the action recognition module 56 to identify the action or movement and produce an indication of the identified movement 184.

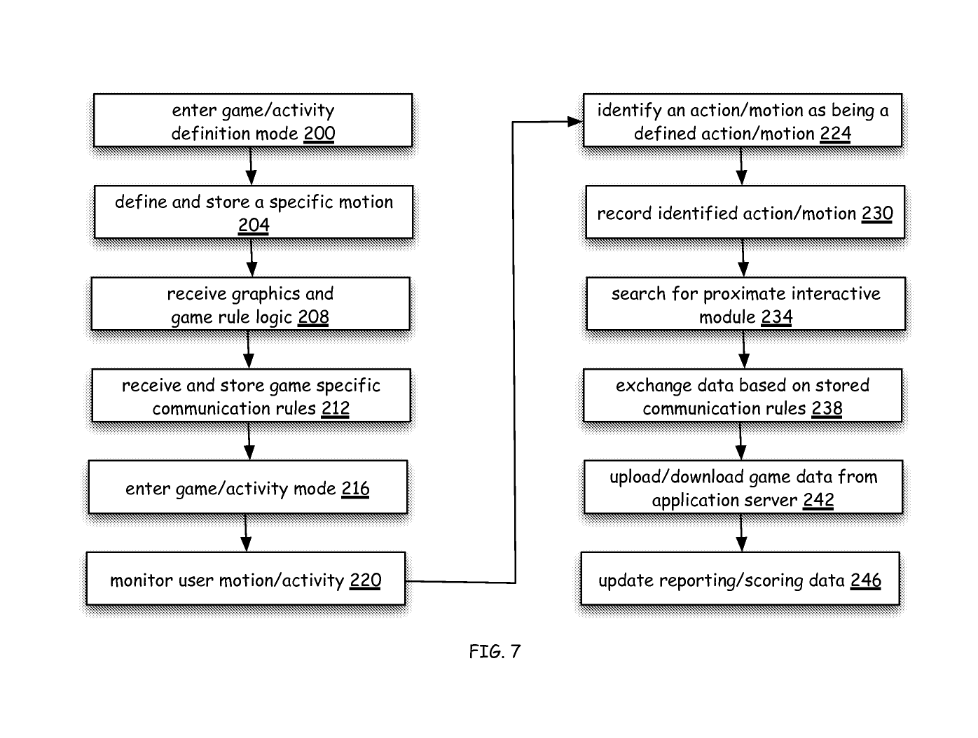

FIG. 7 is a flow chart illustrating a method according to one embodiment of the invention. The method commences with an interactive module entering into a game/activity definition mode (200). The game/activity mode may be initiated in a variety of ways including: a) depressing a control element (button or switch or making a selection based upon a display option), b) powering the interactive module on and then performing a specified action that defines the game/activity definition mode, or c) as a default once the interactive module has been powered on if there are no defined actions stored in memory.

Thereafter, the method includes defining and storing a specific motion or action (204). The step of receiving and storing one or more actions or motions is one step that is required for a game or activity. Another step that may occur prior to or subsequent to recording specific actions or motions is the step of receiving graphics and game rule logic (208) in addition to receiving and storing game specific rules and communication rules (212). For example, once a defined activity is recognized, a game rule may require a score to be recorded and a communication rule may specify when a stored result (e.g., a score) is communicated to another interactive module or to a game console or remote game server via an access point. In one embodiment, the game rules are received from a remote source such as the game console or a remote application server via the Internet and an access point.

Once defined actions are stored and game/activity and communication rules are received or stored, the interactive module is configured to operate in a game or activity mode. Accordingly, the method includes entering into a game/activity mode (216) and monitoring user motion/activity (220). While within a game/activity mode and monitoring data from the position determine circuitry (e.g., position determination circuitry 50 of FIG. 2), the method includes identifying an action/motion as being a defined action/motion (224) and recording an identified action/motion (230). For some games/activities, the interactive module may just record actions/motion without requiring interaction with another interactive module (e.g., exercising, tooth brushing, etc.). For some games/activities, the method includes some level of interaction with another interactive module (even if only for exchanging score or activity information).

For embodiments that require some level of interaction, the method includes searching for proximate interactive modules (234) and exchanging data based on stored communication rules (238). The method also includes uploading/downloading game data from an application server or game console (242) and updating reporting/scoring data to the application server or game console (246). For each instance here in the specification, it should be understood that a reference to communicating with a game or application server or with a game console should understood to mean any type of device that operates as a host for a game or activity and communications with an interactive module to provide game/activity rules, to download or upload scores, game rules, etc.

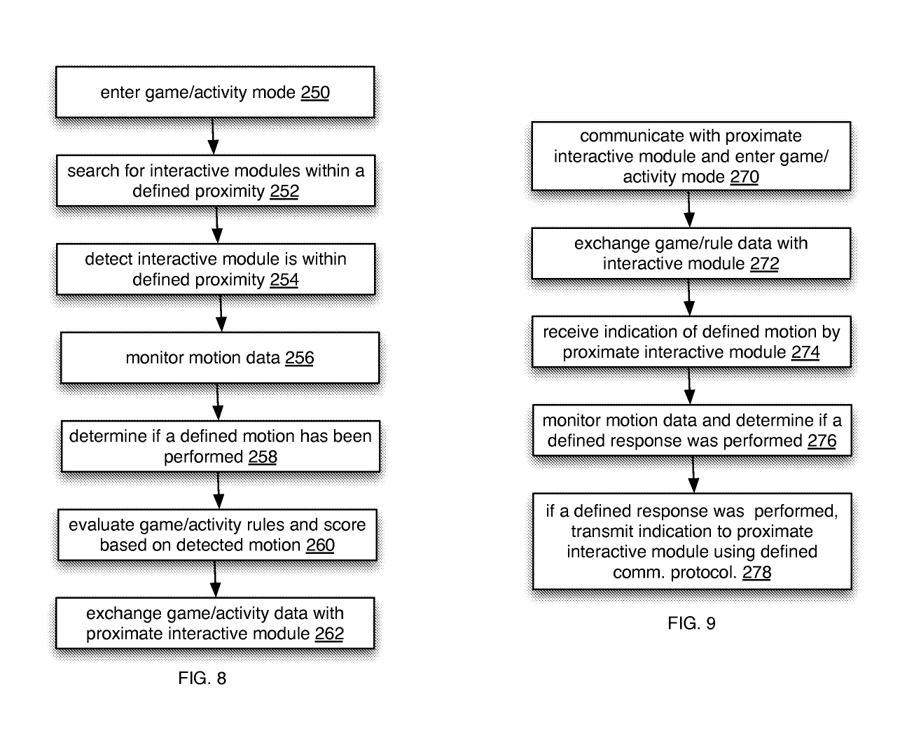

FIG. 8 is a flow chart that illustrates a method according to one embodiment of the invention. The method commences with the step of entering into a game/activity mode (250) and searching for interactive modules within a defined proximity (252). Thereafter, when an interactive module is proximate, the method includes detecting an interactive module is within a defined proximity (254). The defined proximity may be one that is determined via received data from a game console or server and is compared to the interactive modules own location data.

Alternatively, a communication protocol may be used that limits communications to devices that are within a defined distance of each other. For example, near field communication (NFC) technology and protocol may be utilized to initiate a communication between two interactive modules. Thereafter, another communication protocol such as a personal area network (PAN) protocol such as Bluetooth may be used for subsequent communications for games/activities.

Thereafter, the method includes monitoring motion data (256) and determining if a defined motion has been performed (258). If a defined motion or action has been performed, the method includes evaluating game/activity rules and recording a score based on the detected motion (260). The method further includes exchanging game/activity data with proximate interactive module (262).

FIG. 9 is a flow chart that illustrates an interactive method between two interactive modules according to one embodiment of the invention. The method commences with an interactive module communicating with proximate interactive module and entering game/activity mode (270). The method further includes the interactive module exchanging game/rule data with the proximate interactive module (272). It should be noted that the interactive module might exchange game/rule data with the proximate interactive module prior to communicating with it to enter into a game/activity mode.

Thereafter, the method includes receiving an indication of defined motion by proximate interactive module (274). Thereafter, the method includes monitoring motion data and determine if a defined response was performed by the interactive module (276). If a defined response was performed, the method includes transmitting an indication of the defined response to the proximate interactive module using a defined communication protocol (278).

One aspect of the method of FIG. 9 is that the interactive module and the proximate interactive module selectively record actions or responses that are associated with the received indication of an action by the other interactive module. Thus, if a user performs a defined action, but the defined action is not an expected defined action based on the received indication of the proximate interactive module's action, the detected action is not indicated to the proximate interactive module.

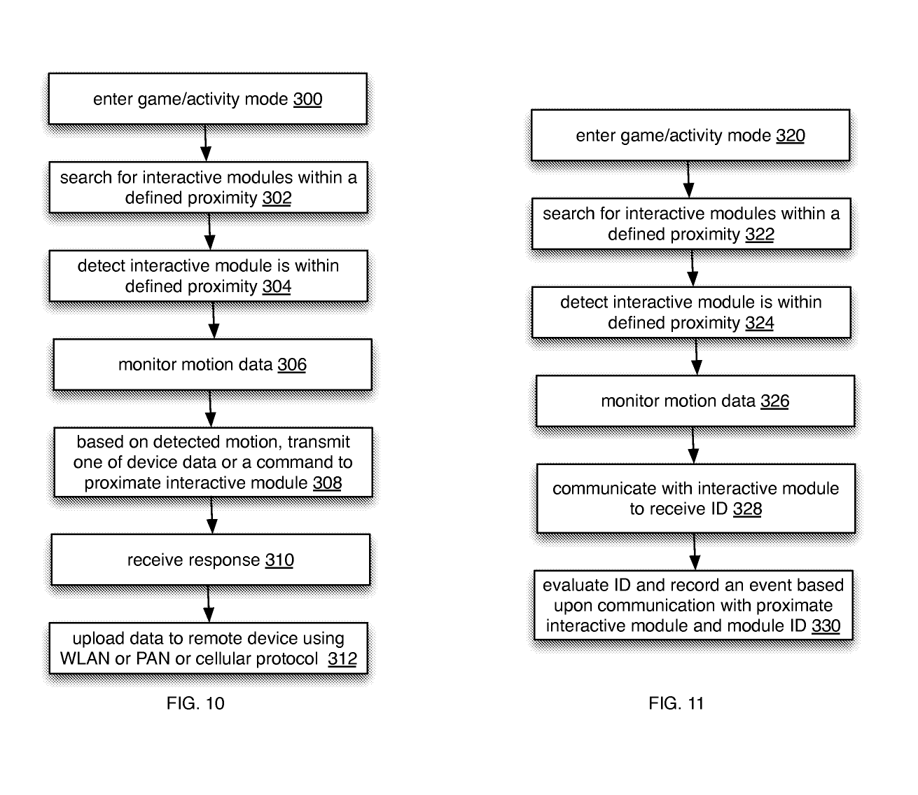

FIG. 10 is a flow chart that illustrates one aspect of an embodiment of the present invention. The method commences with the interactive module entering into a game/activity mode (300) and searching for interactive modules within a defined proximity (302). The searching may include searching for a beacon transmitted by the interactive module that can only be detected when the interactive module is within the defined proximity or it may include monitoring location data transmitted by a game/application server or game console and determining, based on the interactive module's own location information, that the other interactive module is proximate. Thus, the method includes detecting or determining that the interactive module is within defined proximity of a proximate interactive module (304).

It should be understood that steps 300-304 might occur in a different order. For example, an interactive module may not enter into a game/activity mode until after detecting or determining that another interactive module is proximate. Furthermore, this method may omit the step of entering into a game or activity mode of step 300. In an embodiment in which step 300 is skipped, the method merely includes interactive modules interacting with each other based upon determining that they are proximate as defined in the subsequent steps 306-312 below.

Once another interactive module has been determined to be proximate, the method includes monitoring motion data (306) and, based on a detected motion, transmitting either device data or a command to the proximate interactive module (308) receiving response (310). The received response may be a command (e.g., to perform a defined action or motion) or a command to transmit data. Thereafter, the method includes uploading data to a remote device such as a game server, application server, or game console using one of WLAN, PAN or cellular protocol (312). Such communications include exchanges of data, rules, defined actions or motions, or commands.

FIG. 11 is a flow chart that illustrates one aspect of an embodiment of the present invention. The method includes entering game/activity mode (320) and searching for interactive modules within a defined proximity (322). Thereafter, the method includes detecting or determining that an interactive module is within defined proximity (324) and monitoring motion data of the interactive module (326). It should be understood that references herein this specification to monitoring motion data includes monitoring changes in position data to define or detect a defined motion. The method further includes communicating with the proximate interactive module to receive its ID (328), evaluating the received ID and record an event based upon communication with proximate interactive module and module ID (330).

One specific aspect of this method is that the scoring or recording is based not only upon an action of either the interactive module or the proximate interactive module, but also upon the ID of the proximate interactive module. For example, if the ID is one of an interactive module that is on a different team according to the game or activity rules, then the occurrence of an action may result in the action being recorded or, inversely, not being recorded depending upon game/activity rules.

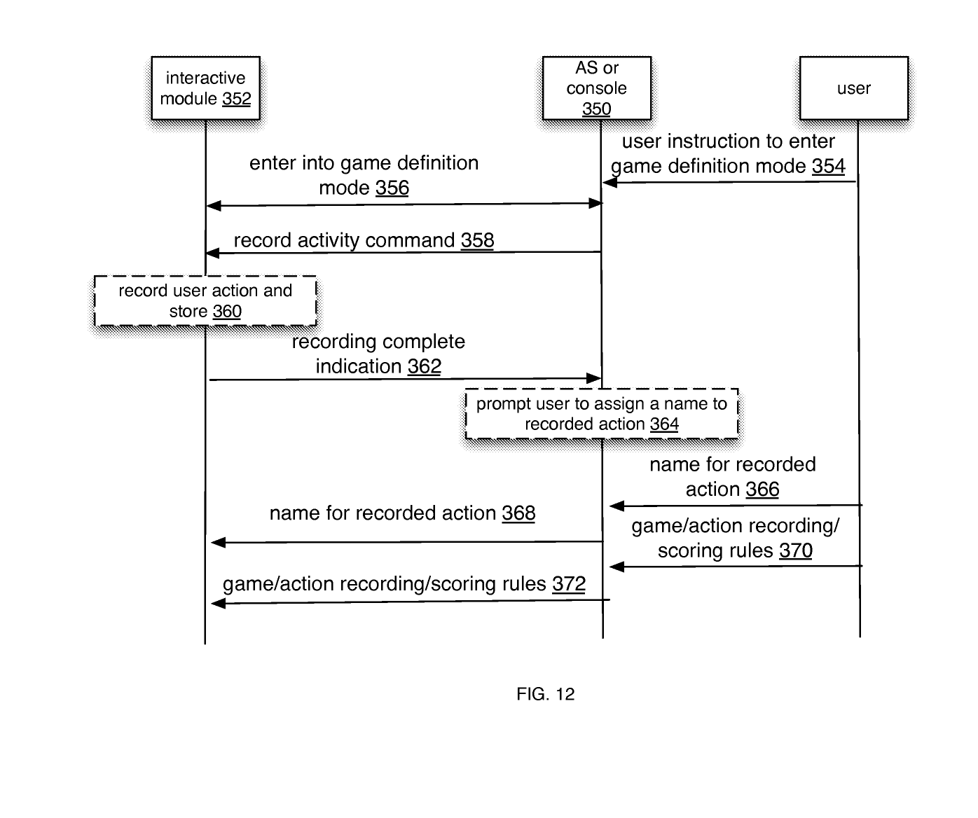

FIG. 12 is a signal flow diagram that illustrates a method according to one embodiment of the invention for defining game/activity rules. A user communicates with an application server (AS) or game console 350 that communicates with an interactive module 352. Initially, a user by way of a user interface enters an instruction to an application server (AS) or game console 350 to enter into a game definition mode (354). AS or game console 352 then transmits a command to interactive module 352 to enter into a game definition mode 356. Thereafter, AS or game console 350 transmits a record activity command 358 to prompt the interactive module 352 to capture a subsequent movement. The user then perform the action with the interactive module 352 and the interactive module 352 records the user action and stores it (360). After the action is complete and has been recorded, interactive module 352 transmits a recording complete indication to AS or game console 350 (362).

AS or game console 350, upon receiving the recording complete indication 362, prompts the user to assign a name to the recorded action (364). The user then generates a name for the recorded action (366). In one embodiment, AS or console 350 had previously received the recorded action. Accordingly, AS or game console 350 assigns the name to the recorded action. Additionally, AS or console 350 transmits the received name to the interactive module 368. Additionally, the user enters game/activity recording and scoring rules in relation, at least partially, to the recorded action 370. Finally, the AS or game console 350 transmits the game/activity recording and scoring rules to the interactive module (372).

It should be understood that one aspect of the invention described in relation to FIG. 12 is that a user, via a user interface, interacts with the AS or game console 350 and indirectly with the interactive module 352 to define actions/activities and to rules including scoring and record keeping rules in relation to the defined actions/activities. It should also be understood that the method might readily be modified by order and by what steps are included in the method. More generally, the method of FIG. 12 allows a user to create games and activities that are based upon user-defined actions.

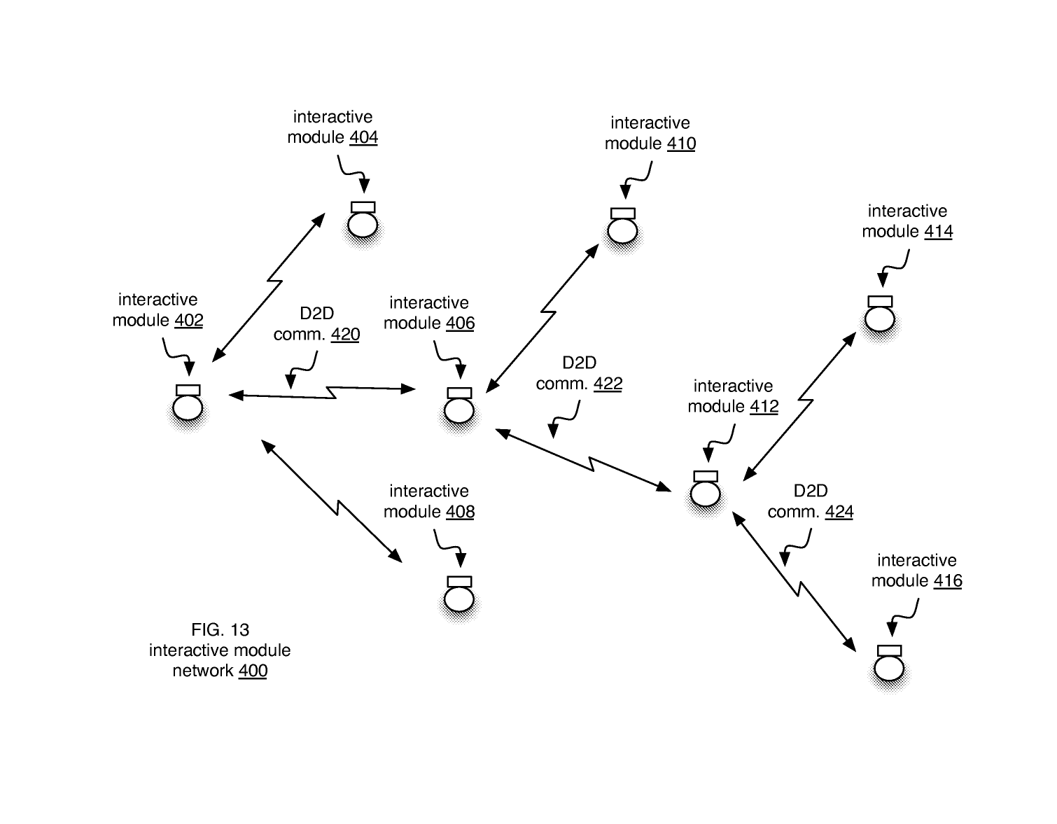

FIG. 13 is a functional diagram illustrating a network of interactive modules that operate according to one embodiment of the invention. Interactive module network 400 includes a plurality of interactive modules 402-416. One aspect of the embodiments of the invention illustrated here is that the devices are configured to engage in device-to-device (D2D) communications as is illustrated by the “bolts” between the various interactive modules 402-416. For the illustration of FIG. 13, if interactive module 402 adds a score or rule or defined action or activity, that score, rule or defined action (“the update”) may be transmitted between the various interactive modules using D2D communications. Thus, module 402 transmits the update to module 406 via D2D communication 420. Module 406 transmits the update to module 412 via D2D communication 422. Module 412 then transmits the update to module 416 via D2D communication 424.

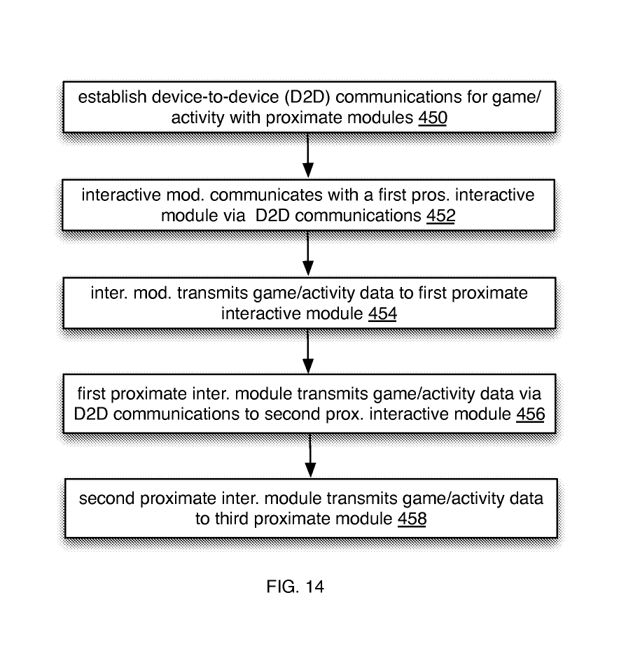

FIG. 14 is a flow chart that illustrates a method of communication in a network of interactive devices according to one embodiment of the invention. The method commences with an interactive module establishing device-to-device (D2D) communications for a game or activity with proximate modules (450). Thereafter, an interactive module communicates with a first proximate interactive device via D2D communications (452). The interactive module transmits game/activity data to the first proximate interactive module (454). The first proximate interactive module then communicates with a second proximate interactive device via D2D communications to forward the game/activity data (456). The second proximate interactive module is one that is not in communication with the first interactive device. The second proximate interactive module then transmits received game/activity data from the second proximate interactive module to a third proximate interactive module (458).

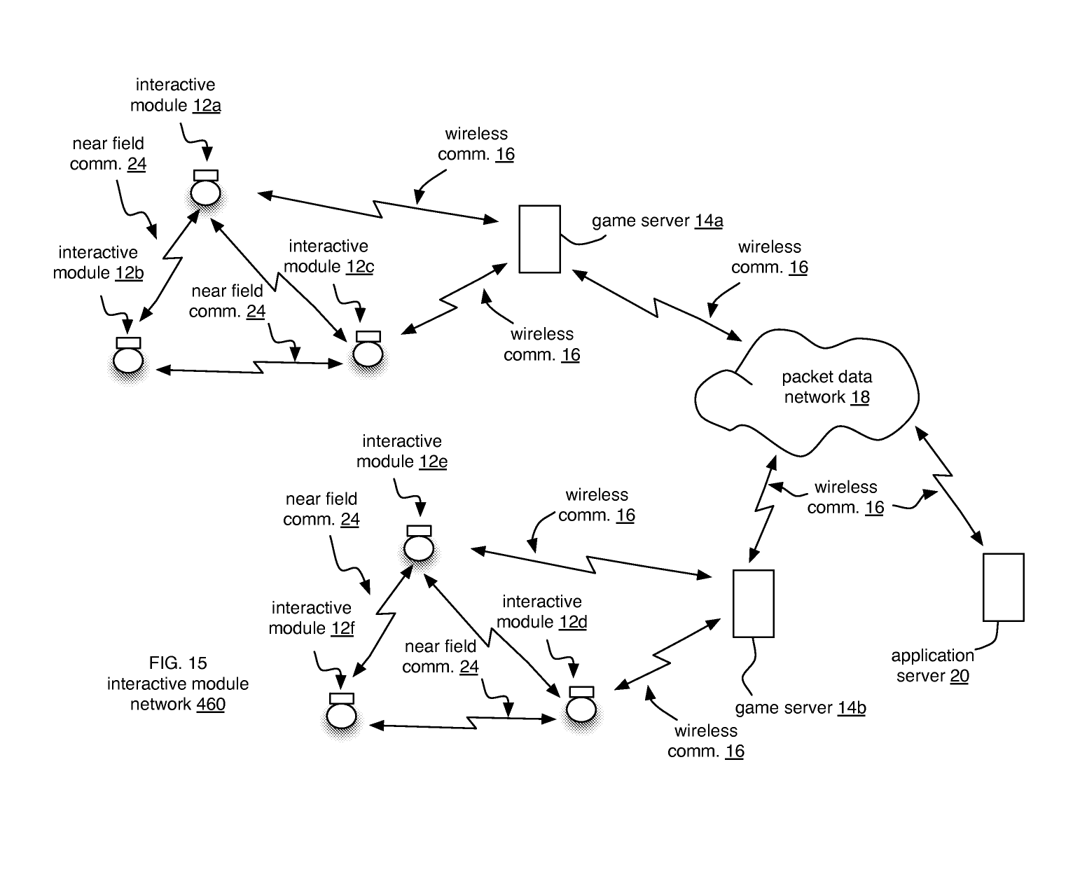

FIG. 15 is a functional network diagram containing a plurality of interactive modules according to one embodiment of the invention. Referring to FIG. 15, an interactive module network 460 includes a plurality of interactive modules 12a-f that are configured to communicate directly with each other in a device-to-device (D2D) mode as well as communicating via one or more of a router, access point, or game/activity server 14a or 14b via a data packet network 18 which can include a world wide packet data network commonly known as the Internet. In one embodiment, a game/activity server 14a-b (hereinafter, game server 14a-b) initializes a game or activity via a wireless communication link 16 with one or more interactive modules 12a-f. A game server 14a-b may be a dedicated device or a computing unit with an associated program or application.

Generally, the network of FIG. 15 includes the same components as illustrated in FIG. 1, but are shown in a different network configuration to illustrate additional aspects of the embodiments of the invention. Accordingly, the discussion in relation to FIG. 1 that relates to the communication technologies as well as the underlying hardware for the interactive modules 12a-f, GS 14a-b, and application server 20 applies here as well.

In one embodiment of the invention, devices such as the first and second interactive modules are operable to determine that they are proximate to each other by detecting a beacon transmitted by the other device and/or a radiofrequency signal that can only be received and recognized within a certain range or distance. In an alternative embodiment, a remote device, such as a game server, generates a communication signal to the interactive devices to inform them that they are proximate to each other. For example, if each interactive module has a position determination circuit, such as a global positioning system (GPS) receiver, the interactive modules can forward location information to the game server, here game server 14, to enable game server 14 to determine with specified logic that the first and second interactive devices are proximate to each other. Once such a determination is made, the game server 14 communicates with the first and second interactive modules to advise them that they are proximate to each other. Alternatively, game server 14 may transmit position information of at least one of the first and second interactive modules to allow one or both of the interactive modules to determine that the other is proximate.

Once the first and second interactive modules have determined that they are proximate to each other, then they may enter into a game or activity mode or, alternatively, a communication mode to exchange game/activity rules or game/activity data (generally, game/activity information). For example, utilizing at least one of position identification circuitry and acceleration determination circuitry, the first interactive module is configured to identify a defined active motion based upon data generated by the position determination circuitry and/or acceleration circuitry that prompts the first interactive module to enter into a corresponding game or activity mode and/or to initiate communications with the second interactive module to jointly enter into the corresponding game or activity mode or to exchange the game/activity information.

Once the first interactive module has not only determined that it is proximate to the second interactive module, but also that a defined active motion that corresponds to the game or activity has been performed by the user, the first interactive module, after establishing a communication link with the second interactive module, stores an indication of the event (based upon identified and defined active motion) and exchanges game/activity information based upon the identified defined active motion directly with the second interactive module. The exchanged game/activity information may be any one or more of an updated score, an indication of the identified action, or even a command or prompt to trigger a desired response by the user of the second interactive module or rules for the game/activity.

In one embodiment of the invention, each interactive module includes memory that stores a library of defined moves and activities. The library of defined moves includes moves that are interactive by nature, such as performing a high five, shaking hands, boxing, dancing, rock paper scissors, copycat moves, exercise moves, hugging, secret handshakes and communication gestures as well as moves for virtual games such as virtual ping-pong.

The library of defined moves also includes moves that are singular and not interactive. For example, the library of the defined moves may relate to identifiable moves such as jogging, tooth brushing, rope jumping, jumping jacks, etc. It should be understood, of course, that the library of defined moves might require the interactive module to be worn on a specified body part to be able to properly identify and record the activity.

Generally, the interactive module may be used not only as a gaming device, but also as a part of a system that encourages certain behaviors and activities such as exercise or tooth brushing. Because the interactive modules are configured to keep a score, or tally or records according to a set of rules, minimum thresholds of certain activities may be defined and subsequently rewarded. For example, the interactive module can not only track how many steps a person walks, how many exercises of a certain type are performed, such as bench presses or jumping jacks, but also other activities such as how many strokes a child used to brush his or her teeth to ensure that the teeth are being brushed properly. Accordingly, award systems may be defined via a user interface to generate an award or recognition of specified accomplishments. In one embodiment, a currency value is awarded for a recognized behavior. This currency can be used to access new levels, gain additional playing time, and acquire weapons, ammunition or additional capabilities. Additionally, the currency may be exchanged with other devices or alternatively cashed in for a reward. For example, an amount of currency can be exchanged via the game server or application server for a reward such as T.V. time.

Additionally, because the interactive module is configured to enter into a selected mode, game or activity that include recognizing actions though the actions may not be in the proximity of a game server, special games may be created and/or defined. For example, the childhood game of tag may be modified to utilize a virtual token that is handed off from one person (or more specifically, one interactive module) to another when the two individuals or devices come into contact with (within a defined distance) each other.

In keeping with the above, games and activities may be defined that require participation by a group of individuals. Additionally, the individuals may be organized into separate groups wherein the scorekeeping or tally is based not only on interaction, but also upon organization or arrangement. Games may be defined, for example, that have two or more teams wherein scoring is based upon an activity in relation to the identity or membership of a proximate individual. One significant aspect of the embodiments of the present invention, therefore, is that record-keeping, which includes keeping a score or tally, depends not only upon identified actions being performed, but also upon determining a relative proximity of an individual or specified device and the group and/or individual identity of that user or user device.

More generally, the capabilities of the interactive modules may be used to encourage fitness and movement, to make individual and group activities more fun, to reward positive behavior, whether individualized or as a part of a group, and to create a unique physical social network. If an interactive module is configured to determine when it is proximate to a specified computer, gaming device, or server, the defined actions may be utilized in conjunction with certain activities for online gaming. Similarly, the interactive module may interact with external devices such as smart phones and accessories of other types to generate commands or data to be transmitted to the extern devices.

As another aspect of the embodiments of the present invention, the interactive modules may be configured to record certain types of activities and motions that are later uploaded to a remote server such as application server 20 via an access point and data packet network such as the Internet. For users that allow such data collection to occur, the data may be utilized to improve target marketing and/or product development. For example, it is known that there are companies that collect such data to render their advertising and product development efforts more efficient and effective.

The embodiments of the interactive modules may include any one of a number of different types of motion and position recognition circuits, devices and systems such as accelerometers, gyroscopes, magnetometers and GPS receivers that may be utilized either singly or in combination to identify location, movement, actions, orientation, speed and acceleration. Any reference herein to position identification circuitry and acceleration determination circuitry should be understood to potentially include any combination of accelerometers, gyroscopes, magnetometers and GPS receivers.

The interactive modules may be packaged or physically configured to be wrist worn (as a watch), or to be worn on other limbs or locations of the body such as the head, leg, upper arm or torso. Generally, the interactive modules will be configured to be stylish or attractive and comfortable to wear as well as to be durable.

Additionally, the interactive modules will include communication circuitry to enable data to be uploaded and downloaded to facilitate coordination, communication and control. For example, in one embodiment, and interactive module may include a USB port to enable the device to be coupled to a computer. Alternatively, or additionally, the interactive modules can include a wireless communication radio and corresponding protocol logic to enable the interactive module to communicate with a computer via a wireless link such as a Bluetooth or a Wi-Fi or WLAN communication protocol such as I.E.E.E. 802.11. The logic would, in the case of Bluetooth, as well as other protocols, include pairing logic to enable the two devices to be paired for subsequent communications.

As another aspect of the embodiments of the present invention, the interactive modules may be configured to store user location information in relation to a downloaded map that is stored in memory to allow a parent to understand where the user, e.g., a child, has gone during the day. Moreover, in one embodiment, such a downloaded map includes defined prohibited areas that prompts the interactive module to generate alarms to remind the user that he or she is within or approaching a prohibited area. In yet another embodiment of the invention, the interactive module includes wireless communication circuitry to enable it to generate text messages for transmission via any one of a cellular communication protocol, a WLAN communication protocol such as 802.11 or a personal area network communication protocol such as Bluetooth to a specified user such as a parent to inform the specified user of the location and/or activity of the person using the interactive module.

An additional aspect of the embodiments of the invention is illustrated here in FIG. 15. In the embodiment of FIG. 15, the interactive modules 12a-f may also interact and communicate with each other via an associated game server 14a-b and packet data network 460 to exchange game data with each other or with the application server 20. In one particular embodiment of the invention, one or more different types of “currency” may be generated for defined actions and game activities. This currency may be utilized to enable different play levels, different play activities (for example, different tools or weapons) and may be exchanged or traded between the interactive modules 12a-f either directly or in a manner coordinated and managed by either the game servers 14a-b or application server 20. The rate at which currency is generated may be a function of the intensity with which an activity is performed or for performing the activity with one or more other interactive modules. In essence, “currency” is a type of credit that is associated with an interactive module or user. For example, a currency may include an amount of time a user has to perform an activity or play a game, or any other capability, game level, etc. Typically, however, a capability, remaining time, game level etc. will be a reward that corresponds to the currency level. One aspect of the invention is that currency is generated according to identified actions or behavior in relation to a set of rules.

In the illustrated embodiment, interactive module 12a may interact with either one of the two proximate interactive modules 12b-c or with any one of the other interactive modules 12d-f. Yet another aspect illustrated here in FIG. 15 is that interactive modules 12b and 12f communicate with an associated game server via a proximate interactive module 12a, 12c, 12d or 12e, respectively. Proximate interactive modules 12a, 12c, 12d or 12e are each configured to support medication relay functionality to route communications between a proximate interactive module and a game server or other proximate interactive module.

In one embodiment of the invention, currency for any particular interactive module is stored in an associated game server 14a-b. Accordingly, if two interactive modules seek to exchange currency types or amounts, such an exchange occurs within one or both of game servers 14a-b dependent on switch to interactive modules are exchanging currency. In this embodiment, game servers 14a-b also upload currency levels for each of the interactive modules 12a-f to application server 20. Alternatively, all currency levels may be stored solely within application server 20. In this embodiment, the game servers such as game servers 14a-b are required to stay synchronized with application server 20 to manage operations of the associated interactive modules 12a-f. In yet another embodiment of the invention, currency levels are delivered to the associated interactive modules 12a-f to allow the interactive modules to activate various features (e.g., access levels or weapons) in a real-time basis during an activity or game. As an interactive module modifies its currency level, the new currency levels are reported to the associated game server 14a-b.

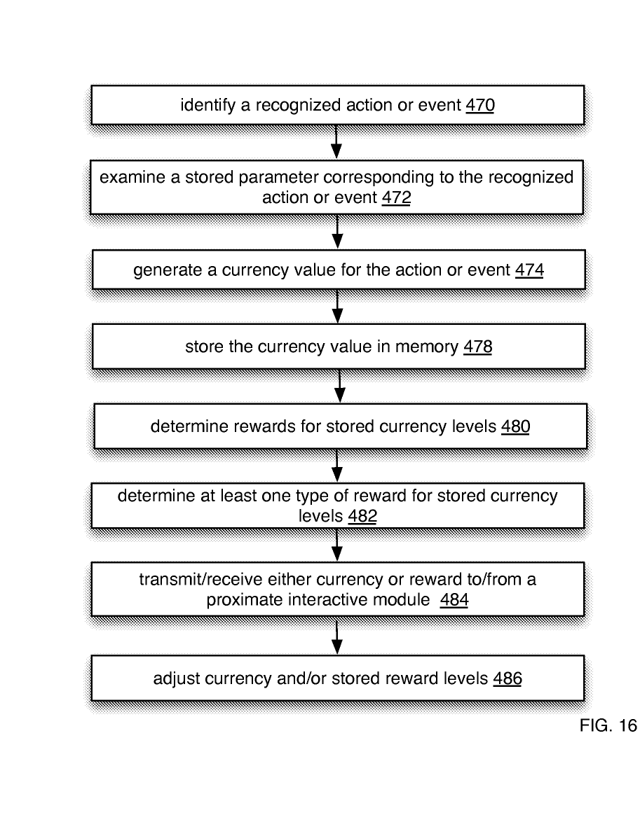

FIG. 16 is a flowchart that illustrates a method for generating currency by an interactive module or by an interactive module and game server or application server. Referring now to FIG. 16, an interactive module identifies a recognized action or event (470). As described previously, the technology within the interactive module, for example, and IMU, an accelerometer, or the like may be utilized to determine a motion pattern and to compare that motion pattern to a library of movements to identify the action or event. Once the action or event has been identified, the method includes examining a stored parameter corresponding to the recognized action or event (472) and generating a currency value for the action or event (474). The currency value is then stored in memory (478). In one embodiment, the memory element used to store the currency value is a labeled memory register and in another embodiment, the currency value stored in a designated area of memory. Subsequently, the method includes evaluating the stored currency levels to determine appropriate rewards or responses (480). For example, if a certain motion is performed a specified number of times, a specified currency reward may be generated. That same specified reward may be generated with other motions, but those other motions may have a different specified number of times or duration of the activity. Moreover, the motion may be compared to an intensity level to generate a specified reward thereby requiring a lower number of motions or alternatively a greater reward. In one embodiment, a type of currency reward may be generated for the recognized action or event based on based on currency levels (482).

One aspect of the embodiments of the present invention is that interactive modules have the ability to exchange rewards and/or currency. Accordingly, the method includes transmitting/receiving either currency or a reward to/from an interactive module (484) with which the interactive module is interacting or communicating. Thereafter, the method includes adjusting the currency and/or stored reward levels within the memory of the interactive module (486).

The above method is in relation to an interactive module that maintains its own currency levels in memory and includes the operational logic to generate specified rewards in currency or other forms based on identified actions or events. Alternatively, an interactive module may communicate all identified or recognized actions and events to a game server or application server to allow the game server or application server to determine and maintain the appropriate corresponding currency levels or reward levels. This embodiment requires a frequent synchronization of data between the game server or application server and the interactive module.

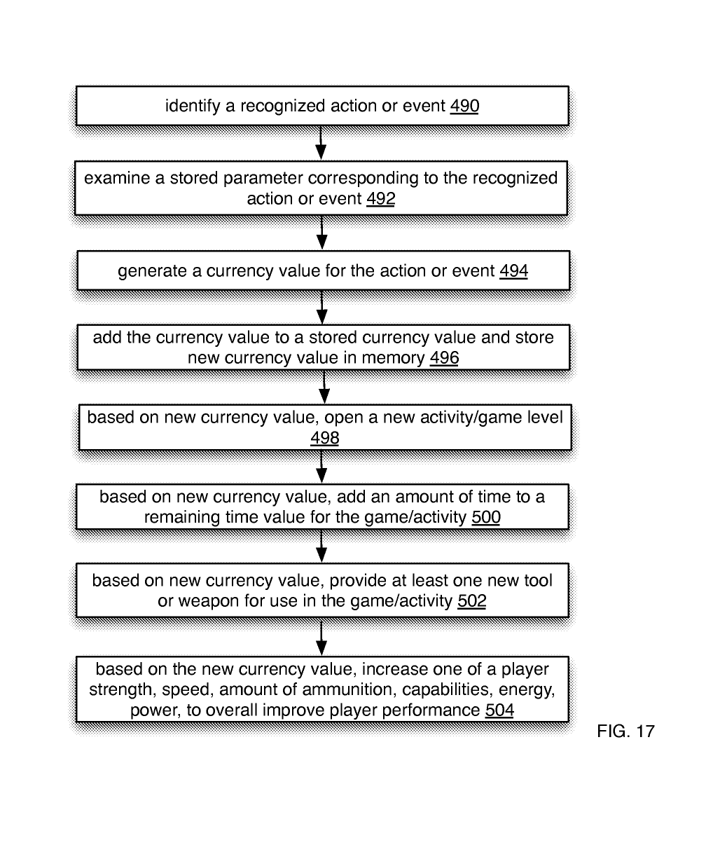

FIG. 17 is a flowchart that illustrates a method for generating currency and reward levels according to one embodiment of the present invention. As with the method illustrated in FIG. 16, portions of the method described in FIG. 17 may be performed by one or more of an interactive module, an application server, or a game server. Referring now to FIG. 17, the method commences with an interactive module identifying a recognized action or event (490). Thereafter, the method includes examining a stored parameter corresponding to the recognized action or event (492) and generating a currency value for the action or event (494). The generated currency value is then added to a stored currency value and the new currency value sum is stored as a new currency value in memory (496).

One aspect of the embodiment of the invention is that activity levels, game levels and reward levels may be generated or awarded based upon the new currency value stored in memory. Accordingly, the method includes, based on the new currency value, opening a new activity/game level or generating a new reward (498). For example, based on the new currency value, the method may include adding an amount of time to a remaining time value for a game/activity (500). Alternatively, the method may include, based on the new currency value, providing at least one of a new tool or weapon for use in the game/activity (502). In yet another alternative embodiment, or aspect of the present invention, the method includes, based on the new currency value, increasing one other player's strength, speed, ammunition or credit levels, capabilities, energy, power, etc., to overall improve the players performance capabilities (504).

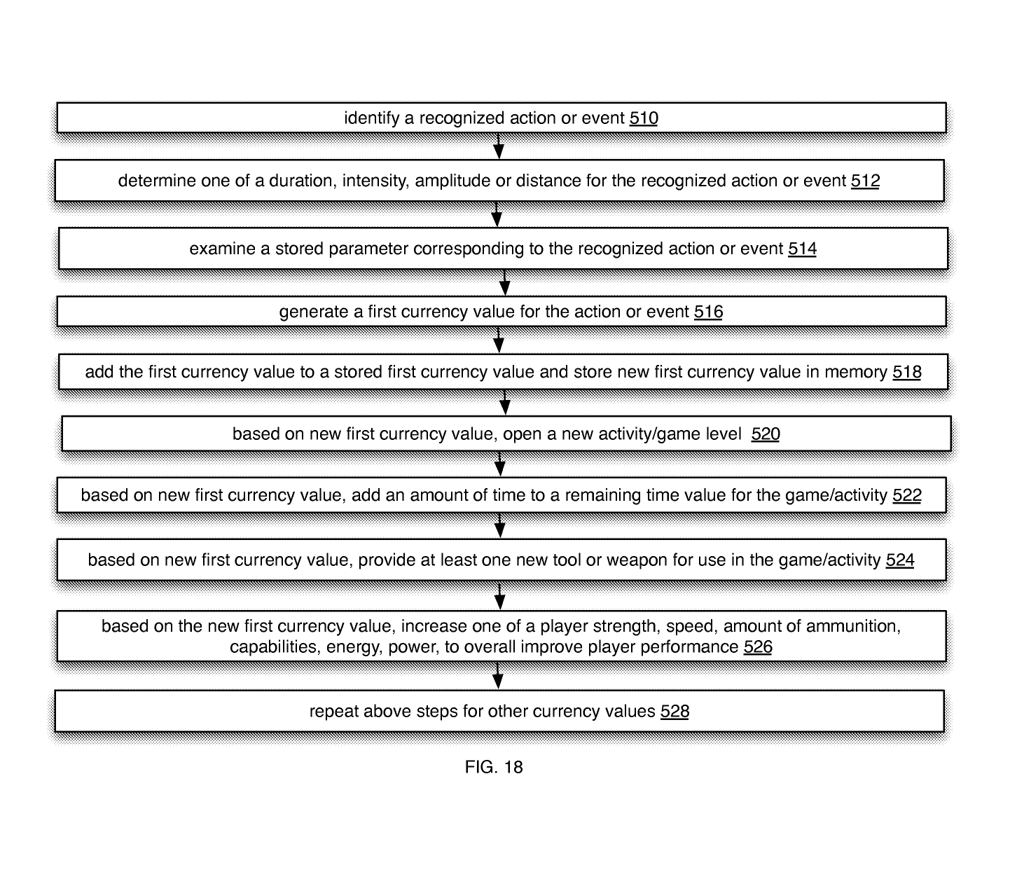

FIG. 18 is a flowchart that illustrates a method for generating currency and reward levels according to one embodiment of the present invention. As described in relation to the prior figures, the method of FIG. 18 may be performed in part by any one or more of and interactive server, a game server, or an application server. As before, the method includes identifying a recognized action or event (510).

Thereafter, the method includes determining one of a duration, intensity, amplitude or distance for the recognized action or event (512), and examining a stored parameter corresponding to the recognized action or event (514) in relation to the duration, intensity, or distance for the recognized action or event. Moreover, in one embodiment, the detected duration, intensity, amplitude or distance may also be evaluated in relation to personal characteristics as a part of ultimately generating a currency (such as in step 512). Thus the parameter may include one that accounts for personal characteristic factors such as user height, weight, stride, age, etc. An older person, for example, may get more credit for an action or event than a younger person due to differences in difficulty based on age. Based on this examination, the method includes generating a first currency value for the action or event (516) and adding the first currency value to a stored first currency value and storing the new first currency value in memory (518).

Thereafter, the method includes, based on the new first currency value, opening a new activity/game level (520). The method further includes, based on the new first currency value, adding an amount of time to a remaining time value for the game/activity (522), or providing at least one new tool or weapon for use in the game/activity (524). Based on the new first currency value, the method includes increasing one of a player strength, speed, amount of ammunition, capabilities, energy, power, etc. to overall improve the player performance characteristics or abilities (526). Finally, the method includes repeating the above steps for other currency values (528). For example, one particular activity may generate a first currency value while another type of activity may generate a second currency value. In one embodiment of the invention, an interactive module, a game server or an application server may store a plurality of currency types and currency values for an associated interactive module.

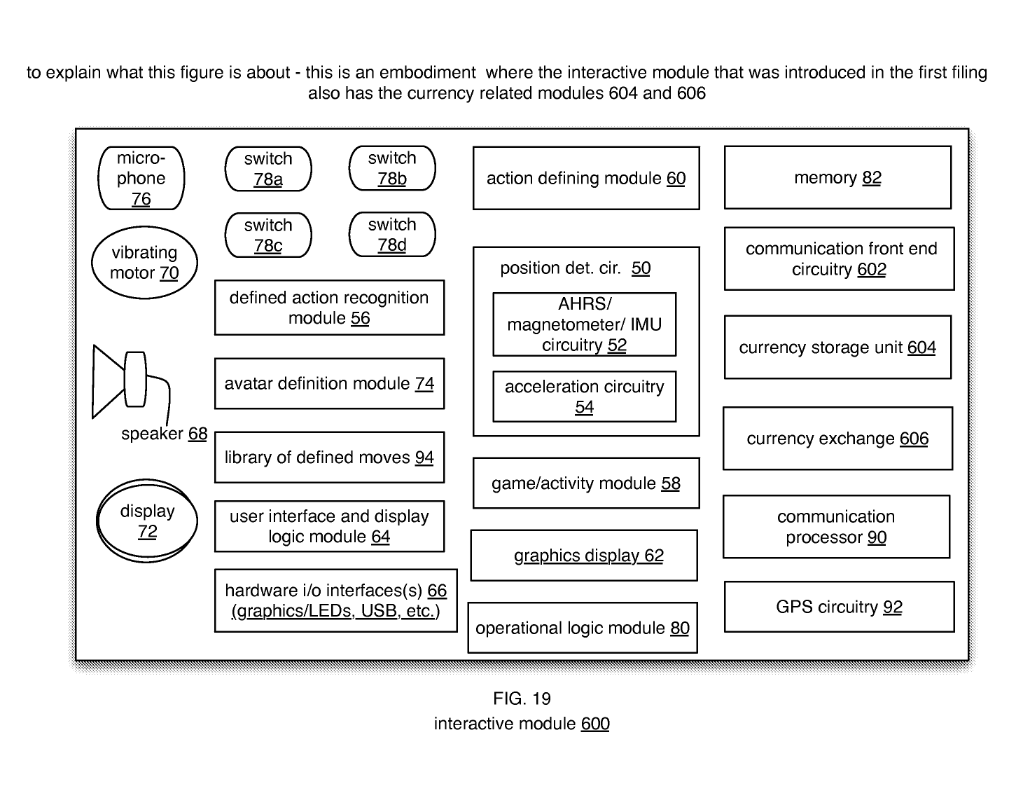

FIG. 19 is a functional block diagram of an interactive module according to one embodiment of the invention. Referring to FIG. 19, interactive module 12 (which can be any one of modules 12a-f of FIGS. 1 and 15 and includes modules that support communications, motion and position and location determination, game and activity rules, displays, interface hardware, and at least one module for identifying defined actions as well as user interface modules. All of these modules work in concert to create an interactive module that supports new types of games and activities not previously supported by existing gaming systems and their input devices.

More specifically, interactive module 600 which is largely similar to interactive module 12 includes position determination circuitry 50 that further includes one or more of an attitude and heading reference system (AHRS), a magnetometer and an inertial measurement unit (IMU) circuitry 52 and acceleration circuitry 54. Interactive module 600 also includes a defined action recognition module 56 that is configured to receive position and/or acceleration data from position determination circuitry 50 to determine if a defined action has been performed.

Interactive module 600 also includes a game/activity module 58 that communicates with defined action recognition module 56 to determine how to interact with another interactive module and/or how to score, record or tally the defined action that was recognized by defined action recognition module 56. For example, game/activity module 58 may include game or activity rules that are processed in view of the recognized actions by defined action recognition module 56 to determine how to record an event or even a mode of operation. Additionally, interactive module 600 includes an action-defining module 60 that defines logic for creating a library of defined actions that may be recognized by defined action recognition module 56. Action defining module 60 is configured to receive position and acceleration data from position determination circuitry 50 while in a learning mode and to store the received position and acceleration data to define an action. The defined actions are then stored in a library of defined moves 94.

In one embodiment of the invention, action defining module 60 is configured to communicate with a user via any one of a plurality of user interface devices, such as graphics display 62, user interface and display logic module 64, hardware I/O interfaces 66, speaker 68, vibrating motor 70, and display 72, to generate prompts and/or to receive names or identifiers for the recorded actions. For example, action-defining module 60 may generate a feedback signal to the user asking the user to give a name to a recorded action that has just been defined. If, for example, an action has been defined, action-defining module 60 may communicate with graphics display module 62 or with display 72 to generate a text message for the user to request that the user enter a name for the recorded action that has just been defined.

Alternatively, action-defining module may prompt a user by generating a message or a light that is displayed directly by display 72. Alternatively, action defining module 60 may generate a voice message or tone that is played by speaker 68 the prompt the user to enter a name for the defined action. A vibrating motor 70 may also be used as a prompt or a feedback device for communicating with the user.

Another way of communicating with the user is through the use of a customized cartoon image (avatar). Accordingly, interactive module 600 includes an avatar definition module 74 that allows a user to create an avatar for communicating results or messages to the user or to prompt the user to perform a specified action.

As may also be seen, interactive module 600 includes a microphone 76 that allows the user to respond to any prompt generated by any means with a verbal response. For example, if action defining module 60 prompts the user to generate a name for a recently recorded and defined action, any voice that is recognized or received by microphone 76 may be produced to processing logic to convert the same to text which is then associated to the newly defined action by action defining module 60.

Continuing to examine FIG. 19, the interactive module 600 includes a plurality of switches 78a-d that may be used for turning a module on or off as well as to select from a variety of options given to the user via any of the user interface display or sound elements.

More generally, an operational logic module 80 includes operational logic to coordinate the plurality of modules and their associated functions and communications with each other as well as with the user. Moreover, a memory 82 includes temporary computer instructions and data as well as computer instructions and data that are stored on a permanent basis or until deleted or replaced. Other circuits or elements of interactive module 12 include a wireless local area network (WLAN) communication front end circuitry 84, personal area network (PAN) 86, near field communication (NFC) front end circuitry 88, as well as a communication processor 90 and global positioning circuitry (GPS) 92.

Each of the modules, circuits and elements of interactive module 12 may be configured to operate according to the various embodiments of the present invention as described here in relation to FIG. 1 described above as well as the figures described below. An interactive module 600 is not required to include all of the modules shown within FIG. 2 or FIG. 19 and may include other modules not described here. Moreover, the logic of the various modules may be combined or defined in different manners.

Any logic of graphics display module 62, for example, may be included with user interface and display logic module 64. Alternatively, user interface and display logic module 64 may define interface related logic for various devices including graphics devices while graphics display module 62 generates actual display signals that are to be shown on a display via an interface controlled by user interface and display logic module 64. It should also be understood that the methods of various flow charts described in the present specification and the logic therefor may be implemented within the various modules and circuitry described in relation to FIG. 19.

Continuing to refer to FIG. 19, interactive module 600 includes a communication front-end circuitry 602. Communication front end circuitry 602 includes communication circuitry that supports communications according to wireless local area network standards such as IEEE 802.11 type communication standards as well as personal area network communications such as Bluetooth and even device to device type communications for devices in near proximity (for example, near field communications).

Interactive module 600 also includes a currency storage unit 604 configured to store one or more types of currency as reward levels for interactive module 600. The currency storage unit 602 may comprise SRAM, Flash, nonvolatile, volatile, and other types of memory. It should be noted that the currency storage unit 604 comprises memory as allocated and organized dynamically for this functionality, namely storing currency values by a software subroutine or logic block in addition to dedicated memory. Interactive module 600 also includes stored currency exchange 606 that evaluates currency exchange rules and logic whenever interactive module 600 engages in a transaction to exchange one of currency or reward values with another interactive module. Currency exchange 606 is configured to access currency exchange rules that may be stored here in interactive module 600 or remotely in an application or game server.

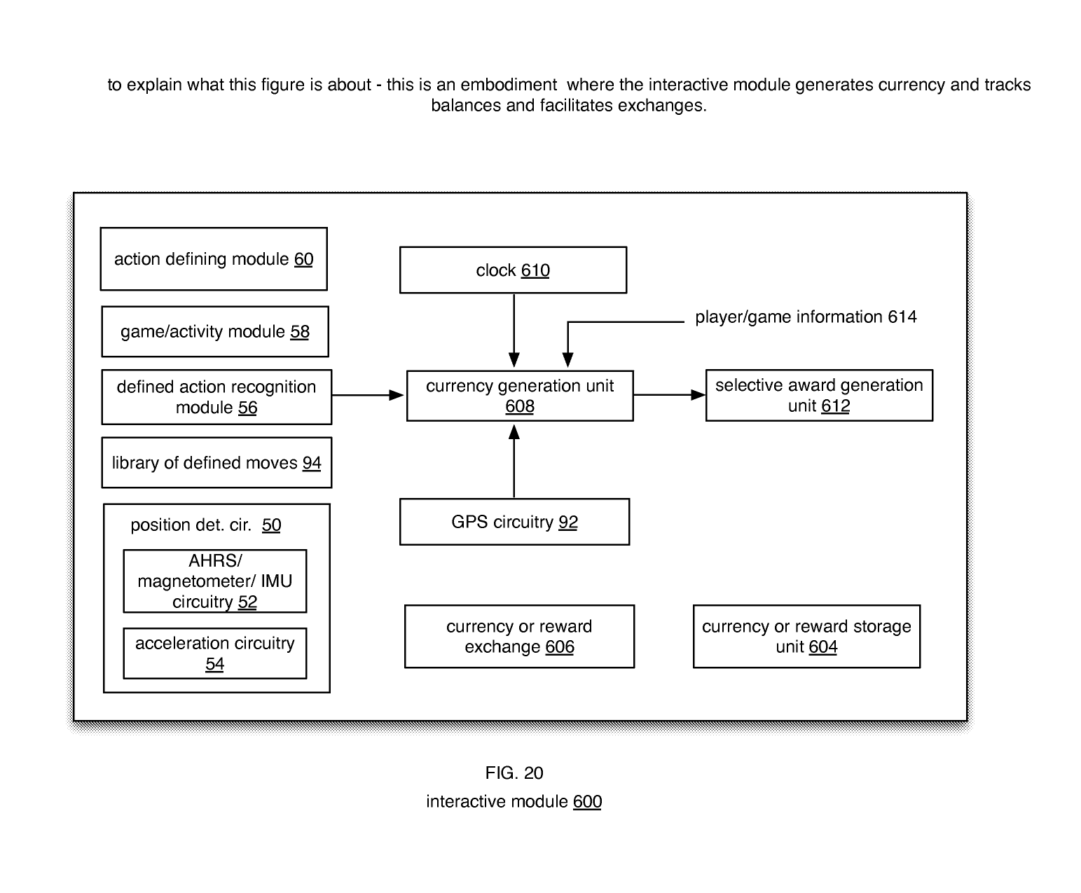

FIG. 20 illustrates various aspects of one embodiment of an interactive module 600. Referring now to FIG. 20, it may be seen that interactive module 600 includes position determination circuitry 50 which includes circuitry AHRS/magnetometer/IMU circuitry 52 and acceleration circuitry 54, as well as defined action recognition module 56, action defining module 60, game/activity module 58, a library of defined moves 94, and GPS circuitry 92. Each of these has been described before. Additionally, interactive module 600 includes currency generation unit 608, currency exchange 606, and currency or reward storage unit 604.

In operation, it may be seen that currency generation unit 608 is coupled to receive a clock value from clock 610, position or location information from GPS circuitry 92, as well as player/game information 614 that is received via communication circuitry regarding player or game information from another interactive module with which interactive module 600 is interacting. Accordingly, by not only performing the defined action as identified by the debt defined action recognition module 56, but also in relation to a location, a clock value, and/or interaction with another player/interactive module, currency generation unit 608 will generate a corresponding currency value according to defined rules or logic stored internally.

The currency that is generated is then produced to selective award generation unit 612 that, if appropriate, generates one or more awards based on the currency generated by currency generation unit 608. For example, if a number of defined actions occur within a specified period, currency generation unit 608 may generate a first currency award. If the same number of defined actions occur within a second specified period, currency generation unit 608 may generate a second currency award. Generally, a certain number of performed actions will be rewarded more highly if performed in a lower amount of time (reflecting increased intensity). Alternatively, currency generation unit 608 may generate a currency reward based on a combination of elapsed time, and/or distance in relation to a defined action that has been recognized by recognition module 56.

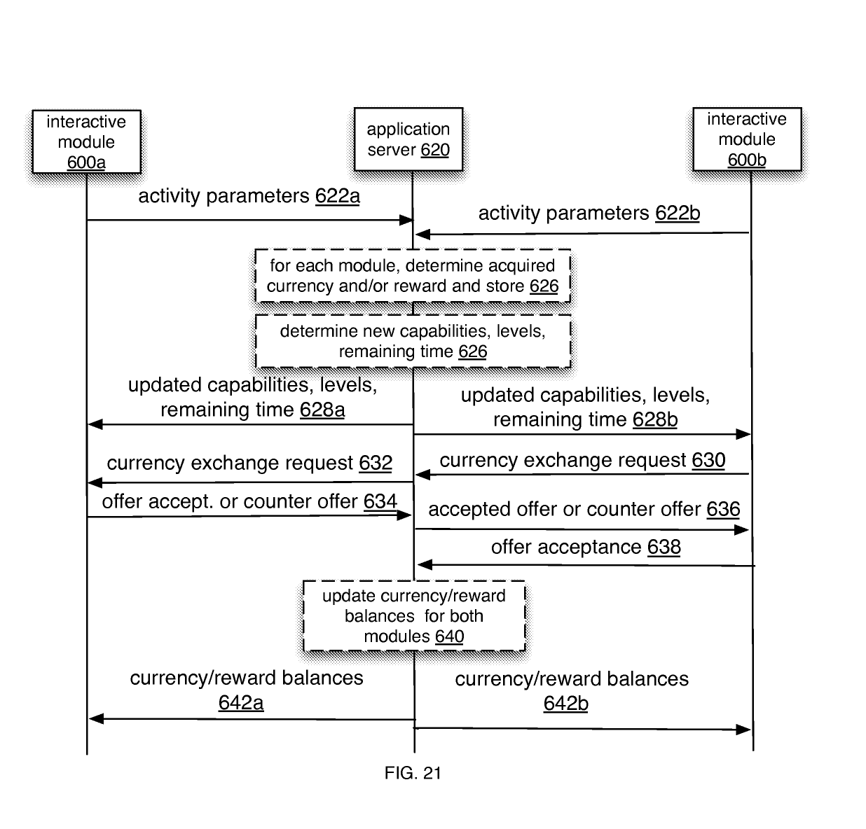

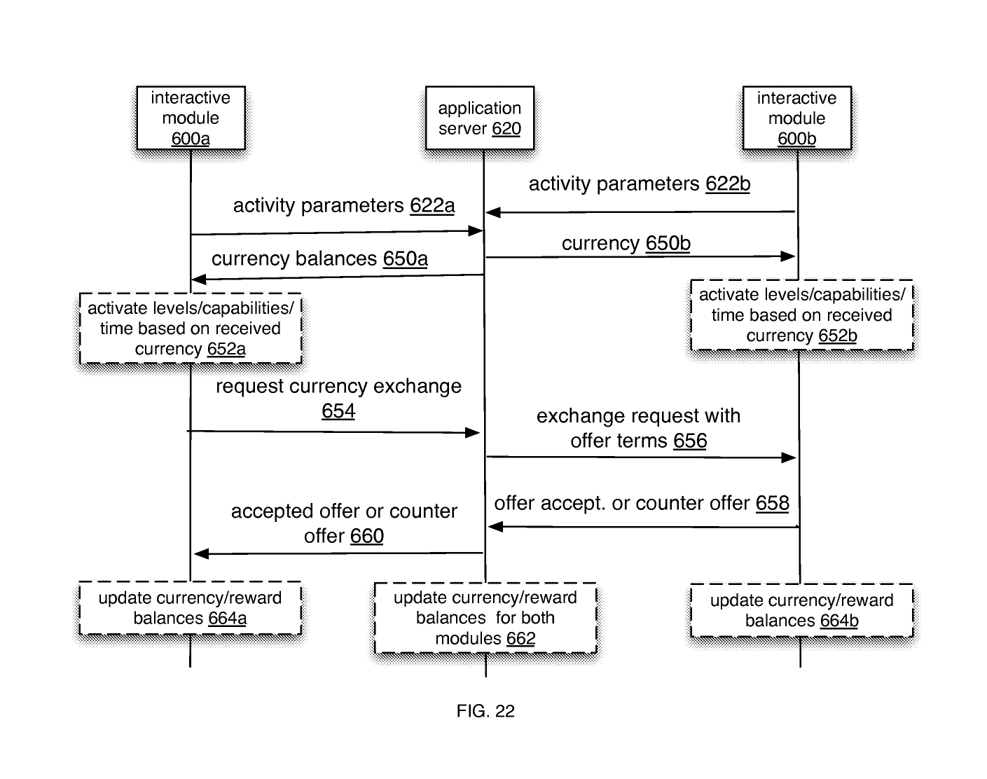

FIG. 21 is a signal sequence diagram that illustrates operation according to one embodiment of the invention. In FIG. 21, two interactive modules 600a and 600b communicate either via a wireless communication protocol directly with each other as well as with an application server or with a wireless gateway device (e.g., a wireless router or game device) that communicates with the application server 620 via a data packet network such as the Internet. Generally, in the embodiment of FIG. 21, the application server 620 stores all currency and reward levels for each of the interactive modules 600a-b and drives all currency and reward exchanges. It should be understood that only two interactive modules are shown here for simplicity but that there could be a substantially greater number of interactive modules operating according to the embodiment illustrated in FIG. 21 (as well as all other figures including FIG. 22 that show the same three devices as FIG. 21).

In operation, interactive modules 600a-b transmit, from time to time, activity parameters (622a-b), respectively, to application server 620. Application server 620 then determines new currency and/or reward levels for each of the interactive modules 600a-b (626) as well as new capabilities, game levels, remaining time (for the game) and other similar or related operational parameters. Application server 626 then transmits the updated capabilities, levels, remaining time and other similar operational parameters to interactive modules 600a-b (628a-b, respectively). The processes described above are repeated either periodically or upon specified events that trigger the process.

Additionally, one aspect of the system of FIG. 21 is that the currency/rewards that have been accrued may be exchanged by the interactive modules. For example, in the example of FIG. 21, interactive module 600b transmits a currency or reward exchange request to application server 620 (630). The request may be directed specifically to interactive module 600a or it may be constructed as a general request that application server 620 is configured to forward to a plurality of interactive modules. Here, application server 620 transmits a currency exchange request to interactive module 600a. Interactive module 600a then sends an offer acceptance indication, a rejection indication, or a counter offer (634). Application server 620 then transmits an indication of an offer acceptance, rejection or counter offer to interactive module 600b (636). Here, interactive module 600b then produces an offer acceptance indication 638 to application server 620. It should be understood that interactive module 600b could have also sent a rejection or counter offer indication.

Once an agreement is reached, application server performs the agreed to exchange by updating currency/reward balances for the associated modules (here, 600a-b) in accordance with the accepted offer (640). Optionally, in one embodiment, application server 620 then transmits currency/reward balances 642a-b to interactive modules 600a-b.

Alternatively, using similar communications, an interactive module may seek to cash in currency for a reward (e.g., a related reward such as playing time or an unrelated award such as T.V. time).

FIG. 22 is a signal sequence diagram that illustrates operation according to an alternative embodiment of the invention. In FIG. 22, two interactive modules 600a and 600b communicate either via a wireless communication protocol directly with each other as well as with an application server or with a wireless gateway device (e.g., a wireless router or game device) that communicates with the application server 620 via a data packet network such as the Internet. Generally, in the embodiment of FIG. 22, the application server 620 stores all currency and reward levels for each of the interactive modules 600a-b as a primary currency and reward storage system and produces at least one of currency and reward balances to the interactive modules 600a-b to enable interactive modules 600a-b to negotiate all currency and reward exchanges with other devices including interactive modules. It should be understood that only two interactive modules are shown here for simplicity but that there could be a substantially greater number of interactive modules operating according to the embodiment illustrated in FIG. 22.

In operation, interactive modules 600a-b transmit, from time to time, activity parameters (622a-b), respectively, to application server 620. Application server 620 then produces currency balances (650a-b) to one or more interactive servers 600a-b. Each Interactive modules 600a-b, upon receiving the updated currency balances, then determines new currency and/or reward levels as well as new capabilities, game levels, remaining time (for the game) and other similar or related operational parameters. As noted in relation to one or more previous figures, a plurality of currencies may be maintained for each interactive module. The processes described above are repeated either periodically or upon specified events that trigger the process.

Additionally, one aspect of the system of FIG. 22 is that the currency/rewards that have been accrued may be exchanged by the interactive modules directly with each other. For example, in the example of FIG. 22, interactive module 600a transmits a currency exchange request to application server 620 (654). Alternatively, the currency exchange request may be transmitted directly to interactive module 600b. The request may be directed specifically to interactive module 600b or it may be constructed as a general request that application server 620 is configured to forward to a plurality of interactive modules. Here, application server 620 transmits a currency exchange request to interactive module 600b.

Interactive module 600b then sends an offer acceptance indication, a rejection indication, or a counter offer (634). Application server 620 then transmits an indication of an offer acceptance, rejection or counter offer to interactive module 600b (636). Here, interactive module 600b then produces an offer acceptance indication or a counteroffer (658) to application server 620 (or directly to interactive module 600a). It should be understood that interactive module 600b could have also sent a rejection. If interactive module 600b sends a counter offer, the counter offer may include specific terms. While only one iteration is shown here, it should be understood that interactive modules 600a and 600b may send a series of counter offers to each other prior to either interactive module 600a-b sending an offer acceptance indication.

Once an agreement is reached as indicated by an offer acceptance indication, application server updates currency/reward balances (662) for the associated modules (here, 600a-b) in accordance with the accepted offer (640) and transmits the new balances to interactive modules 600a-b (not shown here). Alternatively, each of the interactive modules update the currency/reward balances individually (664a-b) and then send the new balances to application server 620. In the event of a conflict in balances, the balance with a most recent timestamp is utilized to harmonize balances.

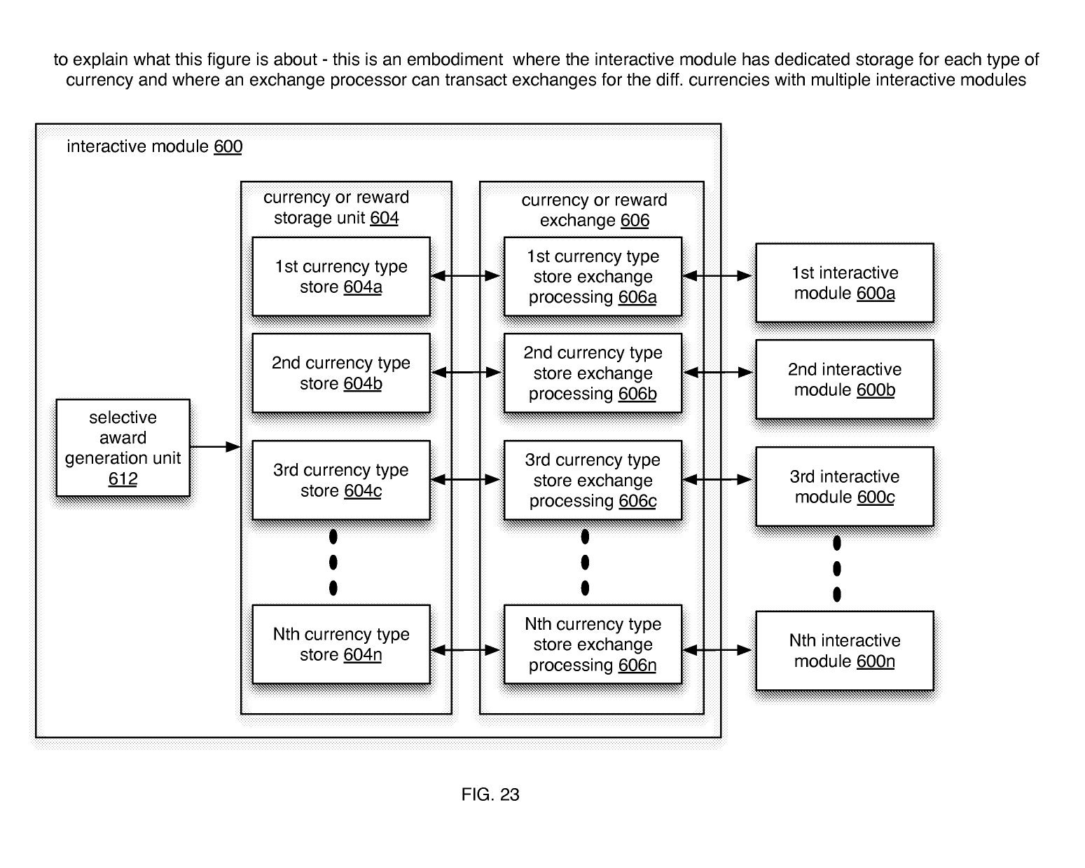

FIG. 23 is a functional block diagram of an interactive module configured to exchange currency with a plurality of interactive modules according to one embodiment of the present invention. Referring to FIG. 23, an interactive module 600 includes a selective award generation unit 612 that generates awards of currency based upon a detected action or event as described previously. Here, a currency or reward storage unit 604 includes a plurality of memory locations or stores for storing a corresponding plurality of currency types or associated rewards. As may be seen, “n” currency type stores are shown for storing n currencies generated by selective award generation unit 612. A currency or reward exchange block 606 is configured to perform a plurality of currency exchanges between interactive module 600 and external interactive modules shown as interactive modules 600a-n. It should be understood that interactive module 600 may not actually engage in currency exchanges with n interactive modules 600 all at once but that interactive module 600 includes that capability. Additionally, it should be understood that interactive module 600 may engage in a currency exchange for a plurality of types of currency with the same interactive module. Specifically, for example, interactive module 600 may exchange a plurality of types of currency solely with 3rd interactive module 600c. It should also be noted that all of the currency types stored within currency or reward storage unit 604 need not be exclusively generated by selective award generation unit 612. One or more of the currency types stored within currency or reward storage unit 604 may have been received from any one of the external interactive modules 600a-n during a currency exchange executed by currency or award exchange block 606.

Another aspect of the embodiments of the invention, which may be explained in relation to FIG. 23, is that the interactive modules may also be replaced by other wireless communication devices that manage currency and reward levels for a user. For example, with an appropriate application, a smart phone may be used to store currency or rewards for a particular user when the user is using interactive module 600. Accordingly the smart phone may manage or track currency and/or reward levels for an interactive module or user.

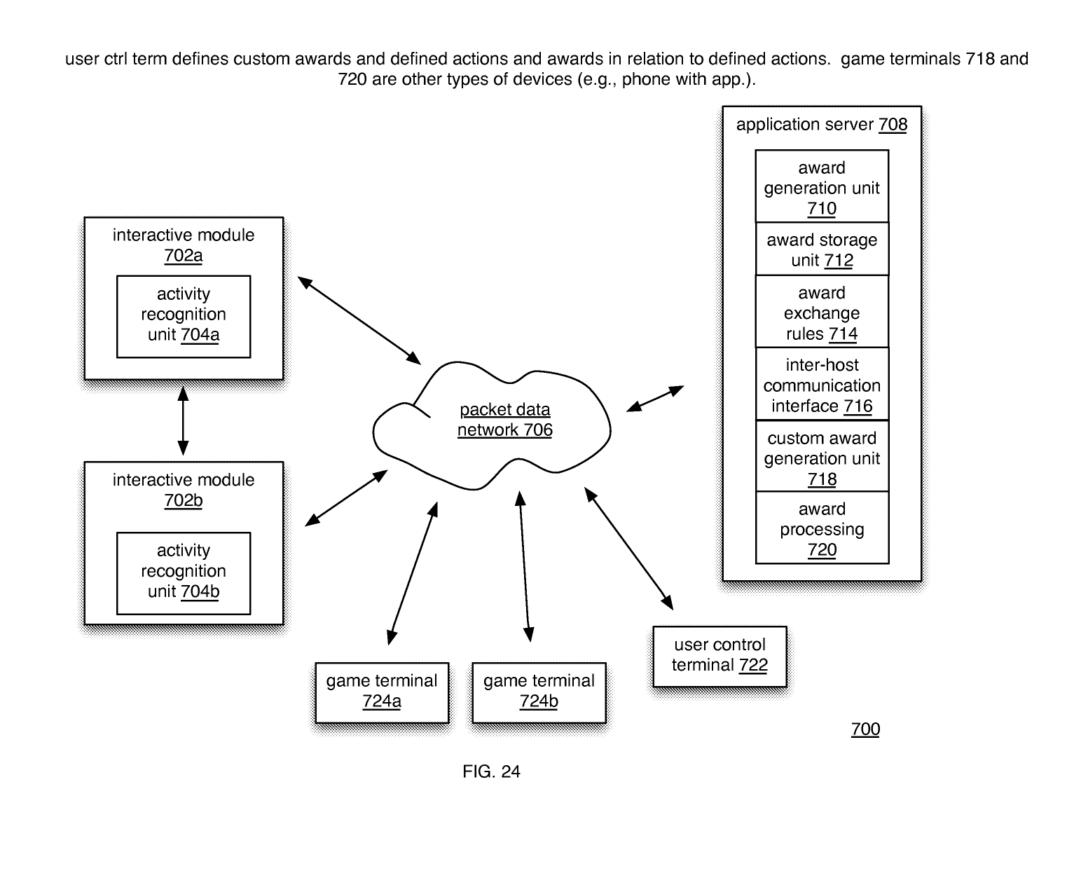

FIG. 24 is a functional block diagram of an interactive system according to one embodiment. Interactive system 700 includes interactive modules 702a-b, a packet data network 706, an application server 708, a user control terminal 722 and game terminals 724a-b. The interactive modules 702a-b, application server 708, user control terminal 722 and game terminals 724a-b are configured to communicate via packet data network 706. It should be understood that such configurations include wireless communication equipment and/or wired communication interfaces and supporting modems and other infrastructure.

Interactive modules 702a-b include activity recognition units 704a-b as well as many other modules as previously described. Application server 708 includes award generation unit 710, award storage unit 712, award exchange rules 714, inter-host communication interface 716, custom award generation unit 718 and custom award processing 720 among other modules previously described.

Though not shown here for simplicity, it should be understood that interactive module 702a-b include storage for storing defined actions and motions as well as movement/action sensing equipment including at least one of an inertial measurement unit (IMU), an attitude and heading reference system (AHRS) and a magnetometer as described before. When the movement/action sensing equipment generates movement/action data, the corresponding interactive module activity recognition unit (704a or 704b) examines defined moves in the storage that stores the defined actions and motions and, when a defined action corresponds to the generated movement/action data, produces an indication of the defined action/motion to application server 708 via packet data network 706.

Activity recognition units 704a-b are configured to produce recognized activity data to application server 708 that not only identifies the recognized activity, but also other associated parameters including, but not limited to duration, a number of times, a rate, etc. For example, if the activity is running, the associated parameters may include either a number of steps or a speed as well as duration. If the recognized activity is jumping jacks, the associated parameter may be a number of jumping jacks. If the activity is a game or group activity, the associated parameter may be a defined event that corresponds to the game or activity (e.g., finding a “treasure”, “tagging” another player, etc.). Application server 708 includes operational logic that is operable to configure and arrange memory structures within award storage unit to store awards associated with recognized activities as well as to store and update award exchange rules, custom defined awards for custom activities, custom award processing rules, and award exchange data to create a record of award exchanges. Moreover, in one embodiment, application server 708 is operable to communicate with user control terminal 722 via packet data network 706 to receive custom award definitions and associated rules that are stored by custom award generation unit 718. Such communications are controlled by inter-host communication interface 716.

Application server 708, and more particularly, award generation unit 710 and custom award generation unit 718, upon receiving the identified recognized activity and associated parameters, will evaluate the received recognized activity and generate an award if appropriate as defined by award generation rules. If an award is to be granted, either award generation unit 710 or custom award generation unit 718 will generate an indication of the award to award processing 720. Award processing 720 communicates with both award generation unit 710 and custom award generation unit 718 to process the award and store the processed award in award storage unit 712. Award storage unit stores generated awards according to at least one of a user ID, a terminal ID, an interactive module ID or a group or team ID according to the type of award and activity being performed. For example, if a team event is being performed, an award may be given to a team ID instead of a user, terminal or module ID. Award processing block 720 includes the defined or stored logic that specifies how awards are to be recorded. Award processing block 720 includes logic to configure award storage unit 720 to the user ID, the terminal ID, the interactive module ID or the group or team ID. User control terminal 722 may interact with award processing block 720 to specify such award generation logic or rules.

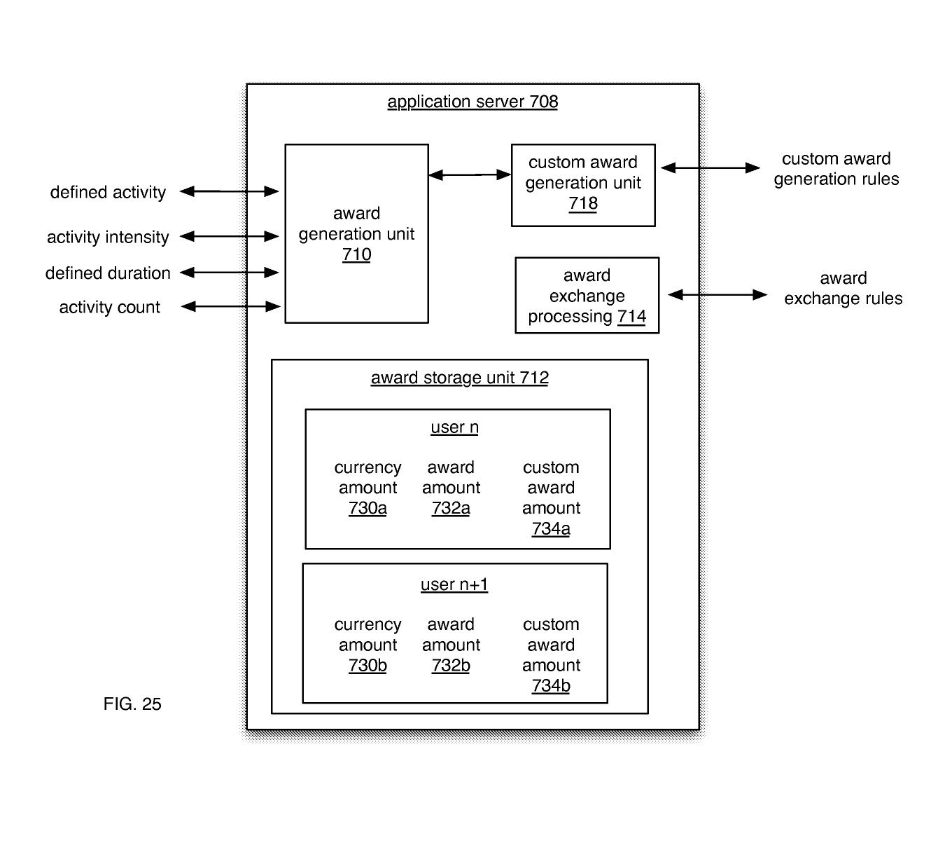

FIG. 25 is a functional block diagram of an application server according to one embodiment. Application server 708 includes award generation unit 710, custom award generation unit 718, award exchange processing unit 714 and award storage unit 712 as previously described as well as other units or modules previously described though not shown here. Award generation unit 710 is configured to communicate with an external interactive module or game terminal to receive identified defined activity information, activity intensity information, activity duration information and activity count information as appropriate for the given activity. Custom award generation unit 718 is configured to receive and store custom award generation rules.

Application server 708 therefore configures its internal memory and logic to store and execute the received custom award generation rules. Custom award generation unit 718 communicates with award generation unit 710 to generate custom awards based on the received activity information. Award exchange processing unit 714 is configured to receive and store award exchange rules. For example, two interactive modules or game terminals may elect to exchange awards according to the award exchange rules. In one embodiment, the award exchange rules may be defined by a user in real time as a part of a negotiation to execute the exchange. For example, one simple rule might be that an award of one type is worth two awards of another type. Alternatively, awards may be contingent upon a future event. For example, an award is given to the recipient for performing a specified activity and is decremented and given to another party (user, device, team, etc.) if the specified activity is not performed according to associated award generation rules (e.g., within a specified time period).

In one embodiment of the invention, a defined activity results in the generation of a currency. Different activities may have the same or different types of currency. Accordingly, application server 708 is configured to arrange memory storage areas of award storage unit 712 to store, on a per user, device or ID basis, an associated currency amount, an award amount, and a custom award amount. Referring to FIG. 25, memory space is allocated for each user (represented by users “n” and “n+1”), for storing a currency amount 730a-b, an award amount 732a-b, and a custom award amount 734a-b.

In addition to allowing users to “exchange” awards, a user is able to “spend” generated currency. Such currency may be used to “buy” additional games, activate game levels, purchase tools, ammunition, capabilities, etc. For example, if user control terminal 722 specifies that an award is an amount of time a game or number of games may be played by a particular user or device in relation to a specified amount of currency, a user may generate currency for defined activities that then are exchanged for access to the game based upon the rules specified by the user terminal 722. To illustrate, a parent may specify via the user terminal 722 that any one game or all games may only be played for a duration based on currency generated for performing a recognized activity such as any one of a plurality of exercises. Other defined activities may generate currency such as brushing teeth, sweeping, running, walking, dancing, etc.

While much of the preceding discussion has been in relation to interactive modules such as modules 702a-b, it should be understood that the system can also interact with game terminals 724a-b. Game terminals 724a-b may comprise dedicated gaming systems or, alternative, a computing unit such as a desktop, a laptop, a personal access device (e.g., Apple™ iPad™), or a mobile phone. Typically, such devices will have an installed application or game that allows the computing device to interact with application server 708 for a particular game or activity.

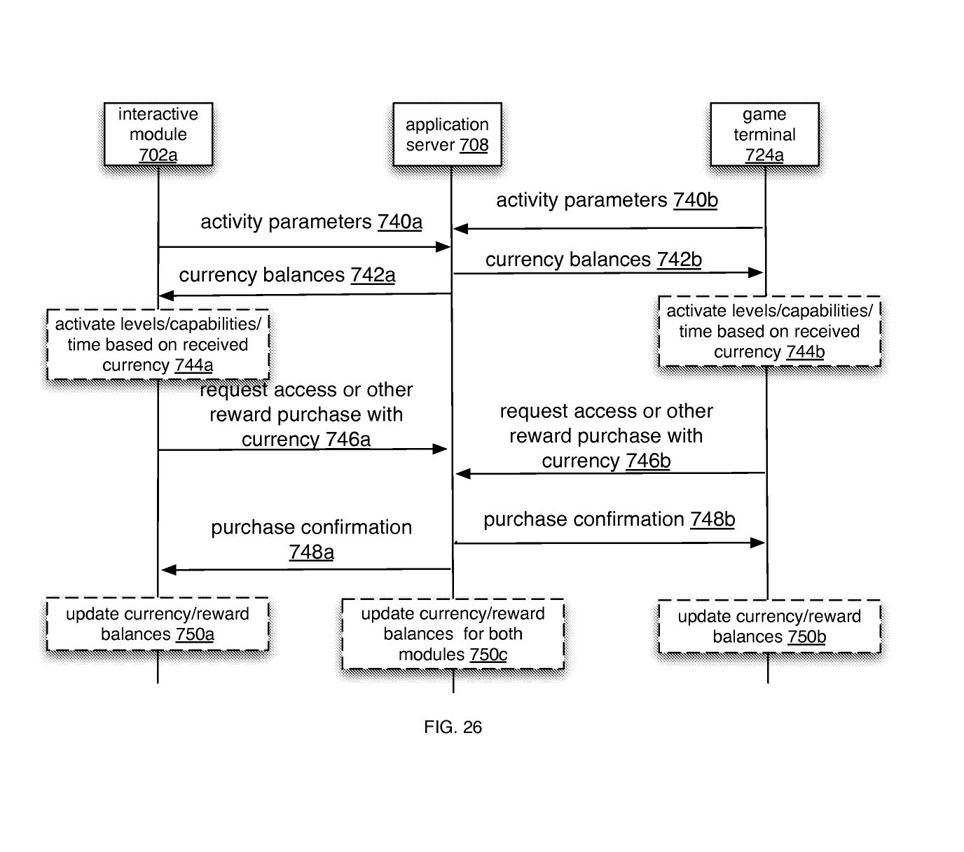

FIG. 26 is a signal sequence diagram that illustrates one aspect of the embodiments of the present invention. Here, an interactive module 702a and a game terminal 724a interact with application server 708. As specified activities are performed, activity parameters 740a-b are transmitted to application server 708 by interactive module 702a and game terminal 724a, respectively. Application server 708 updates currency balances and transmits the currency balances 742a-b to interactive module 704a and game terminal 724a, respectively.

Interactive module 702a and game terminal 724a update levels/capabilities/time allowed for a game or activity based on the received currency balances 744a-b, respectively. Subsequently, in one embodiment, interactive module 702a and/or game terminal 724a request access or other rewards that may be purchased with specified amounts of currency 746a/b, respectively. Application server then sends acknowledgment or purchase confirmations 750a-b to interactive module 702a and/or game terminal 724a, respectively. Thereafter, interactive module 702a, game terminal 724a and application server 708 each update currency/reward balances for the corresponding device or user or group ID, correspondingly 750a-c, respectively.

While FIG. 26 shows both interactive module 702a and game terminal 724a performing similar steps (communications or processes) at similar times, it should be understood that the aspect being demonstrated in FIG. 26 is that either type of device may perform similar activities or engage in similar communications with application server 708 depending on the capabilities defined with the device or application being executed by the associated device and/or device capabilities.

It should also be understood that these aspects could be combined with those aspects of other figures such as those of FIG. 22. Thus, an interactive module may, for example, use currency to purchase something controlled by another device such as game terminal 724a or user control terminal 722. For example, such currency may be transmitted to user control terminal 722 to purchase television time. Such exchanges would be defined within application server 708 (previously defined by user control terminal 722, for example). As such, currency is not required to be used to purchase rewards that are unrelated to a particular activity except as specified within application server 708.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A method for a first interactive module, comprising:
establishing a communication link using one of a personal area network protocol, a near field communication protocol, wireless local area network communication protocol or a cellular communication protocol and generating an interactive session with a second interactive module;
arranging a storage unit to store a library of defined moves in relation to an identifier for each of the defined moves wherein each of the stored defined moves comprises a data pattern that correspond to data generated by at least one of an inertial measurement unit (IMU), an attitude and heading reference system (AHRS) and a magnetometer;
arranging a storage area to record identified actions and events and credits of at least one type;
identifying at least one of the defined actions or events based upon data generated or data produced by at least one of the inertial measurement unit (IMU), the attitude and heading reference system (AHRS) and the magnetometer;
storing an indication of the identified action or event in the storage area;
generating a credit based upon the stored action or event;
transmitting a credit exchange request intended for the second interactive module;
receiving one of an acceptance, a rejection or a counter-offer from the second interactive module;
receiving updated credit balances; and
storing the updated credit balances.

2. The method of claim 1 wherein the first interactive module transmits the credit exchange request directly to the second interactive module in a peer-to-peer type communication via one or more intermediate communication devices.

3. The method of claim 1 wherein the first interactive module transmits the credit exchange request to one of an application server or a game server for forwarding.

4. The method of claim 3 wherein application server or a game server forwards the credit exchange request to the second interactive module.

5. The method of claim 3 wherein application server or a game server forwards the credit exchange request to the second interactive module via a packet data network.

6. The method of claim 3 wherein application server or a game server forwards the credit exchange request to a plurality of interactive modules including the second interactive module.

7. The method of claim 3 wherein application server or a game server forwards the credit exchange request to a plurality of interactive modules including the second interactive module via a packet data network.

8. The method of claim 1 further comprising generating a plurality of types of currency or rewards as a type of credit for the identified actions or events.

9. A method for a first interactive module, comprising:
establishing a communication link using one of a personal area network protocol, a near field communication protocol, wireless local area network communication protocol or a cellular communication protocol and generating an interactive session with a second interactive module;
identifying a defined action or event based upon data generated data produced by at least one of an inertial measurement unit (IMU), an attitude and heading reference system (AHRS) and a magnetometer;
storing an indication of the identified action or event;
generating a currency based upon the stored action or event; and
exchanging one of the currency or a reward either with the second interactive module or with a third module.

10. The method of claim 9 wherein the first interactive module generates an exchange request with specific offer terms to exchange one of the currency or the reward.

11. The method of claim 9 further comprising generating a plurality of types of currency or rewards for the identified actions or events.

12. The method of claim 9 wherein the step of identifying the defined active motion is based upon data generated by at least one of position determination circuitry and acceleration circuitry.

13. An interactive module, comprising:
at least one of an inertial measurement unit (IMU), an attitude and heading reference system (AHRS) for detection position and motion, and magnetometer;
communication circuitry;
a controller configured to arrange a configuration in memory to store a plurality of specific motions and actions and to store at least one type of credit associated with recognized actions;
an action recognition module configured to receive action and movement data from at least one of the inertial measurement unit (IMU), the attitude and heading reference system (AHRS), and the magnetometer to compare the received action and movement data motions and actions to identify actions and movement;
credit processing module configured to determine an amount and type of credit to assign for the identified actions and movement; and
wherein the interactive module:
generates credits for identified motions and actions;
transmits credit information associated with one of a user or the interactive module to a remote device; and
engages in negotiations communications with another device to exchange the credits.

14. The interactive module of claim 13 configured to determine awards based on the credits.

15. The interactive module of claim 14 configured to engage in negotiations communications to exchange the rewards.

16. The interactive module of claim 13 configured to determine awards based on the credits.

17. The interactive module of claim 13 configured to generate the credits or rewards based upon a specified interaction with another interactive module.

18. The interactive module of claim 13 configured to generate the credits or rewards based upon a specified interaction with another interactive module and based upon the other interactive module being proximate and engaging in related actions or activities.

19. An interactive computer system useful for interactive games and activities, the system comprising:
a computer store containing data relating to patterns of actions and movements, currency values, time values, game and activity data, user data, game rules, currency exchange rules, communication rules, programming rules including rules to define patterns of actions and movements, action interpretation logic;
position determination circuitry configured to measure movement, location, acceleration and other movement parameters;
graphics processing circuitry configured to generate displays on a screen;
communication circuitry configured to communicate over a plurality of wireless communication technologies including at least two of Bluetooth, I.E.E.E. 802.11 WiFi communication protocols, near field communication (NFC) protocols, at least one cellular communication protocol and configured to receive global positioning satellite (GPS) communication signals;
a processor configured to retrieve data and computer instructions that define operational logic to recognize defined actions and activities and wherein the computer system:
establishes a communication link using one of a personal area network protocol, a near field communication protocol, wireless local area network communication protocol or a cellular communication protocol and generating an interactive session with a second interactive module;
identifies at least one of the defined actions or events based upon data generated or data produced by at least one of the inertial measurement unit (IMU), the attitude and heading reference system (AHRS) and the magnetometer;
stores an indication of the identified action or event in the storage area;
generates a credit based upon the stored action or event;
transmits a credit exchange request intended for a second interactive computer system;
receives one of an acceptance, a rejection or a counter-offer from the second interactive computer system;
receives updated credit balances; and
stores the updated credit balances.

20. The system of claim 19 wherein the interactive computer system transmits the credit exchange request directly to the second interactive computer system in a peer-to-peer type communication via one or more intermediate communication devices.

21. The system of claim 19 wherein the interactive computer system transmits the credit exchange request to one of an application server or a game server for forwarding.

22. The system of claim 21 wherein an application server or a game server forwards the credit exchange request to the second interactive computer system.

23. The system of claim 19 wherein at least one of what games, game levels, game parameters, and time left to play a game is based on the credit balances and updated credit balances.
